(19) United States
(12) Patent Application Publication
(10) Pub. No.: US 2025/0109950 A1
(43) Pub. Date: Apr. 3, 2025

(54) SYSTEMS AND METHODS FOR NAVIGATING PATHS

(71) Applicant: Apple Inc., Cupertino, CA (US)

(72) Inventors: Matthew J. ALLEN, Menlo Park, CA (US); David A. KRIMSLEY, Sunnyvale, CA (US); Kevin M. LYNCH, Woodside, CA (US)

(21) Appl. No.: 18/900,718

(22) Filed: Sep. 28, 2024

Related U.S. Application Data
(60) Provisional application No. 63/587,091, filed on Sep. 30, 2023.

(51) Int. Cl. G01C 21/34; G01C 21/36; G06V 20/58

(52) U.S. Cl. CPC G01C 21/3415; G01C 21/3691; G06V 20/58

(57) ABSTRACT

In some embodiments, an electronic device navigates and/or travels using predetermined paths and/or impromptu paths. In some embodiments, the electronic device generates the impromptu paths based on characteristics, criteria, and/or factors relating to the environment of the electronic device. In some embodiments, the electronic device outputs indications of impromptu paths to be used for navigating and/or traveling.

### CROSS-REFERENCE TO RELATED APPLICATIONS

This application claims the benefit of U.S. Provisional Application No. 63/587,091, filed Sep. 30, 2023, the content of which is herein incorporated herein by reference in its entirety for all purposes.

### FIELD OF THE DISCLOSURE

This disclosure relates generally to an electronic device presenting content, such as content captured using one or more cameras.

### BACKGROUND OF THE DISCLOSURE

User interaction with electronic devices has increased significantly in recent years. These devices can be devices such as computers, tablet computers, televisions, multimedia devices, or mobile devices. While presenting content using an electronic device, the user may wish to modify playback of the content. The user may therefore desire efficient ways of playing content.

### SUMMARY OF THE DISCLOSURE

Providing efficient ways of navigating predetermined and impromptu paths may improve the user's experience with the electronic device and reduce the number of inputs needed to reach a destination, thereby reducing power usage and improving the battery life of the electronic device.

In some embodiments, an electronic device navigates or travels on predetermined paths and/or impromptu paths. The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIGS. 3A-3G is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIG. 5I illustrates an example system for implementing techniques described herein.

FIGS. 6A-6J illustrate exemplary ways in which an electronic device navigates or travels on predetermined paths and/or impromptu paths according to some embodiments of the disclosure.

FIG. 7 is a flow diagram illustrating a method in which an electronic device navigates or travels on predetermined paths and/or impromptu paths according to some embodiments of the disclosure.

### DETAILED DESCRIPTION

The following description sets forth exemplary techniques for impromptu paths. This description is not intended to limit the scope of this disclosure but is instead provided as a description of example implementations.

There is a need for electronic devices that navigate and/or travel on predetermined and/or impromptu paths. In some embodiments, an electronic device generates one or more impromptu paths based on one or more characteristics, criteria, and/or factors related to the environment of the electronic device. Further, such techniques efficiently navigate and/or travel on predetermined and/or impromptu paths, thus reducing the number of inputs needed to reach a destination, thereby reducing power usage and improving the battery life of the electronic device.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### Exemplary Devices

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example, on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

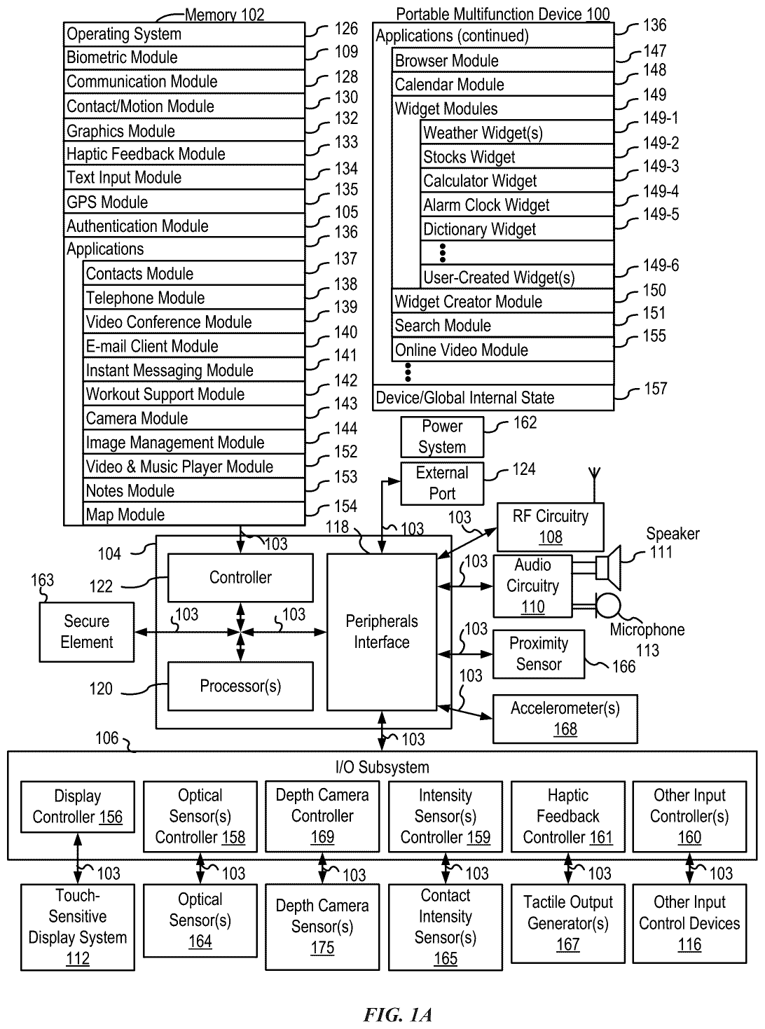

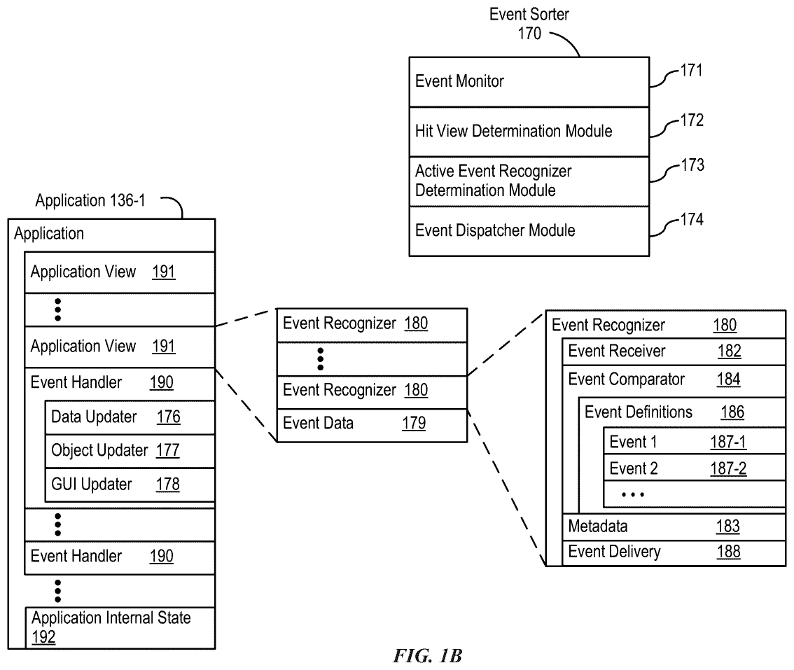

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

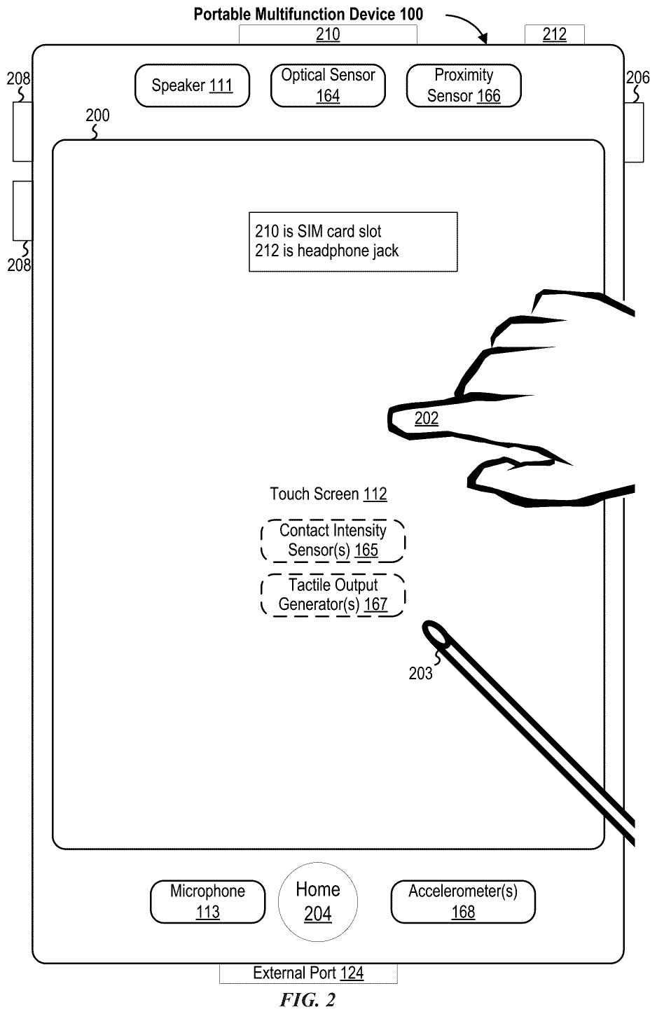

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/48,264, “Gestures For Touch Sensitive Input Devices,” filed Jan. 31, 2005; (5) U.S. patent application Ser. No. 11/38,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

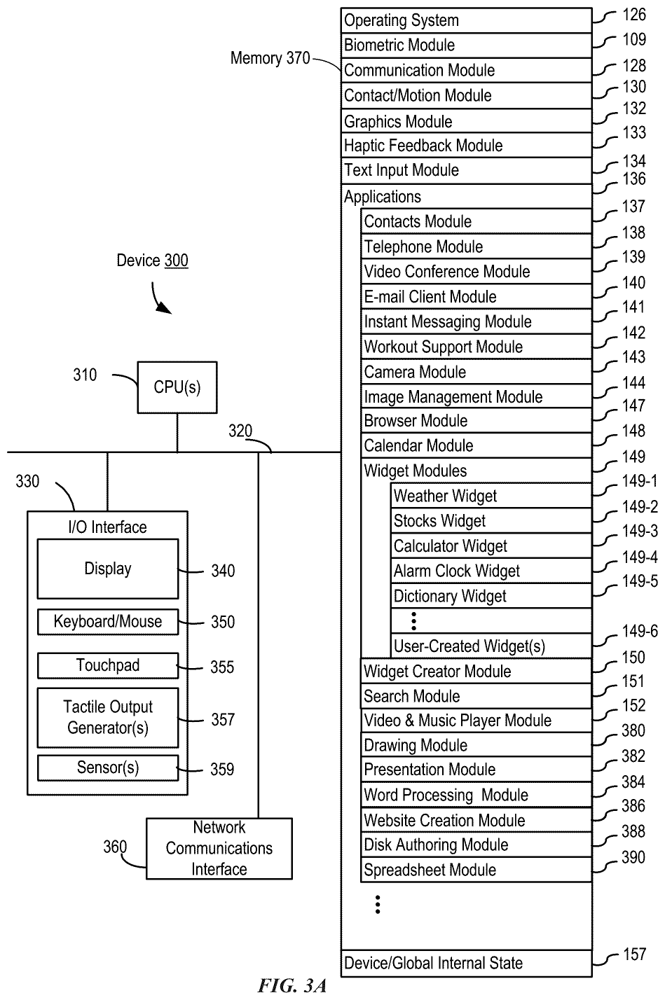

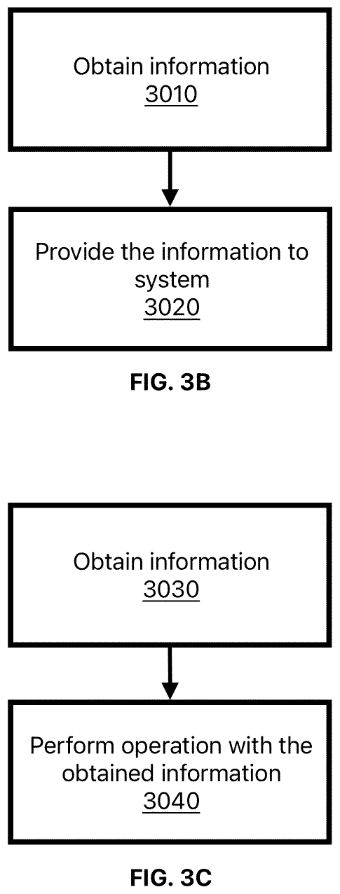

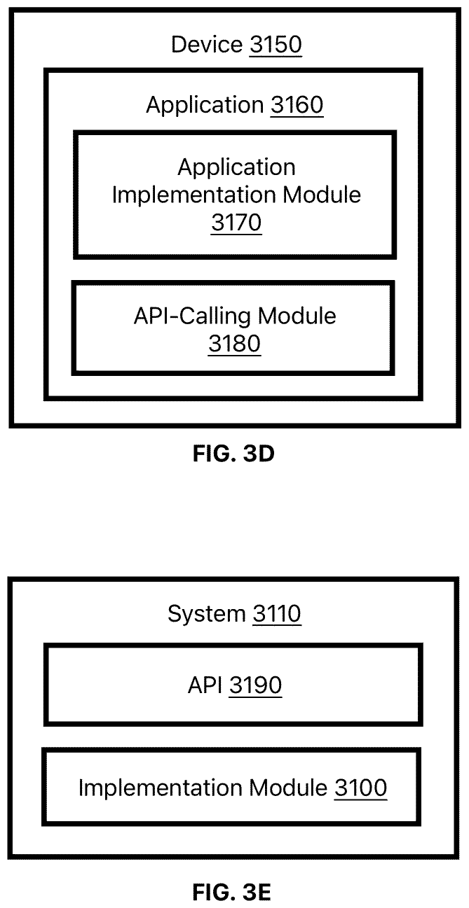

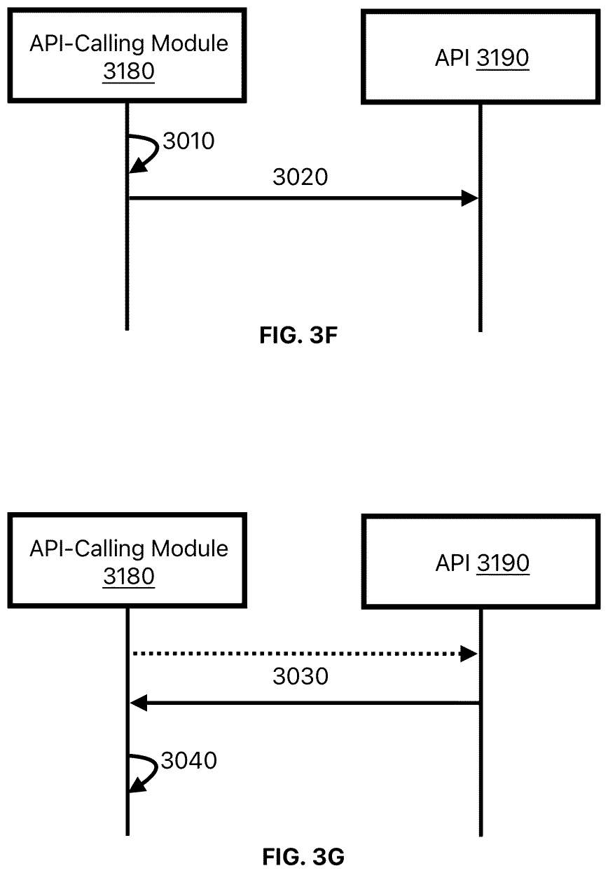

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,67, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

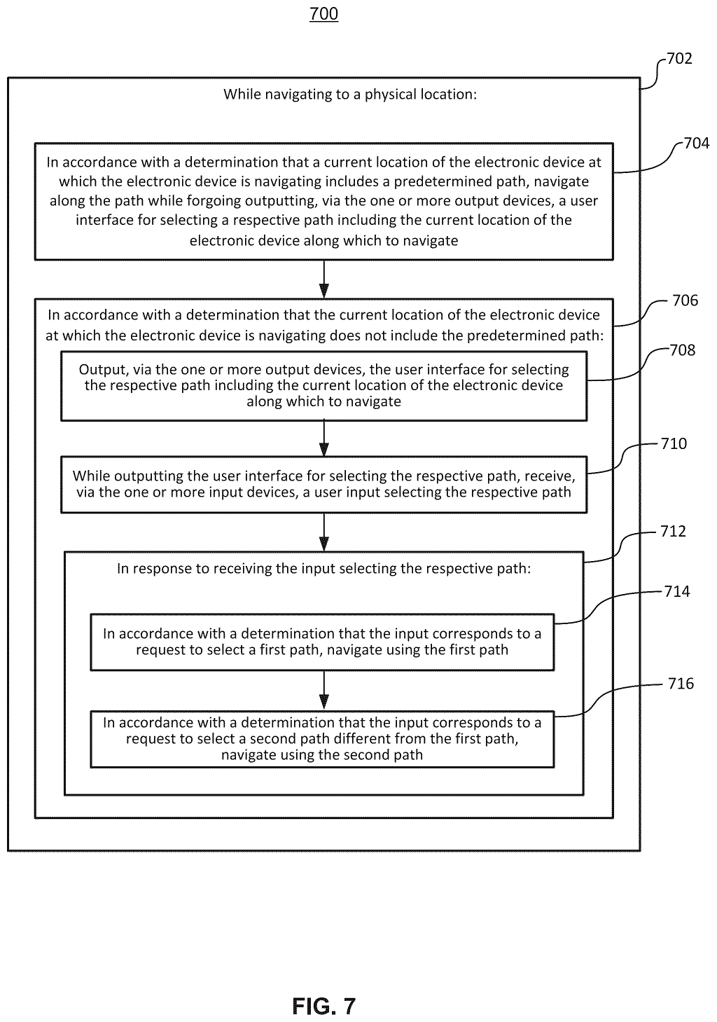

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7) and/or method 900 (FIG. 9) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

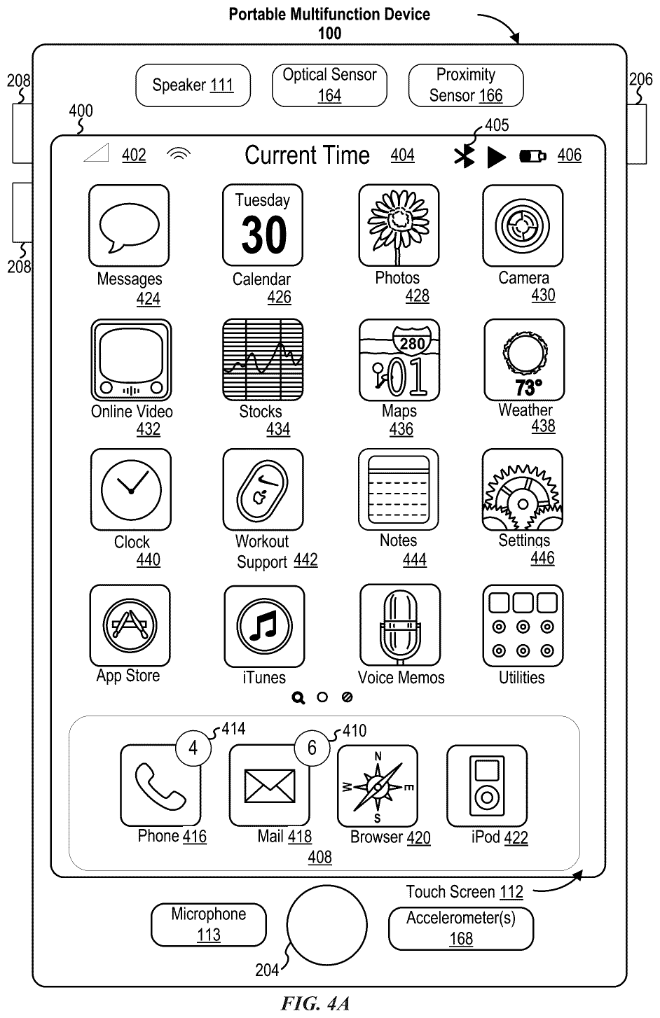

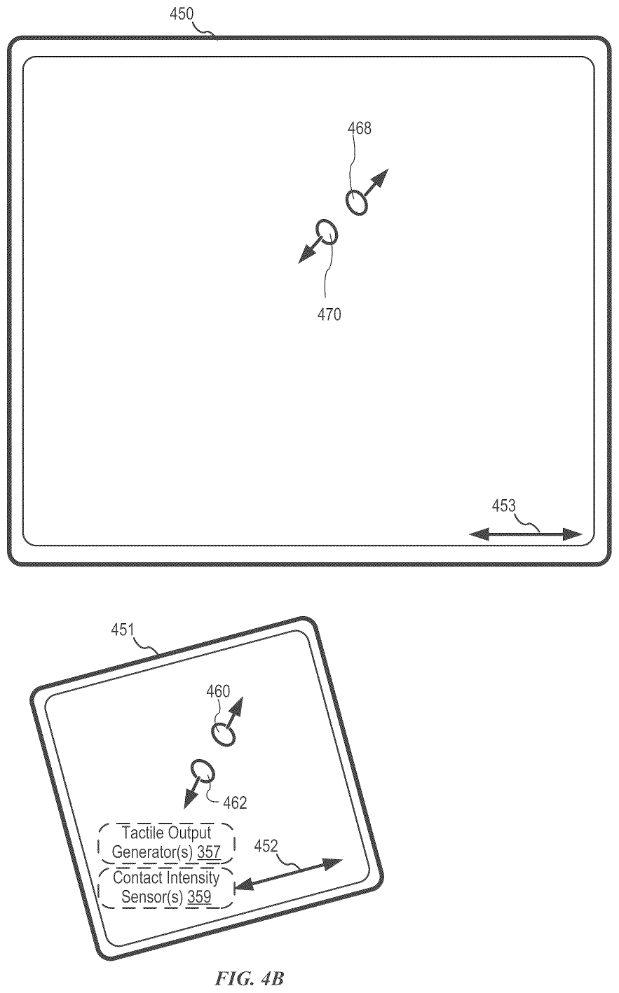

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
   Icons for other applications, such as:
Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

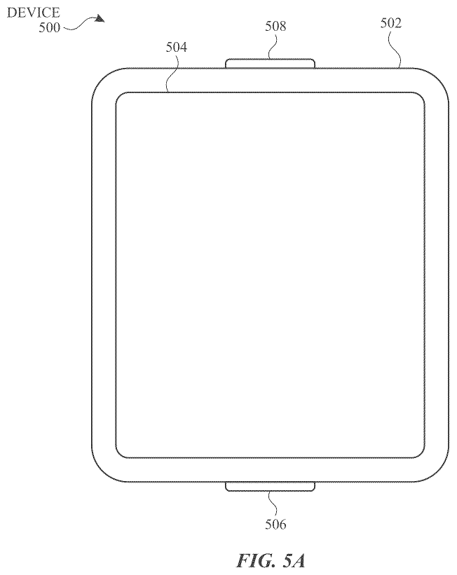

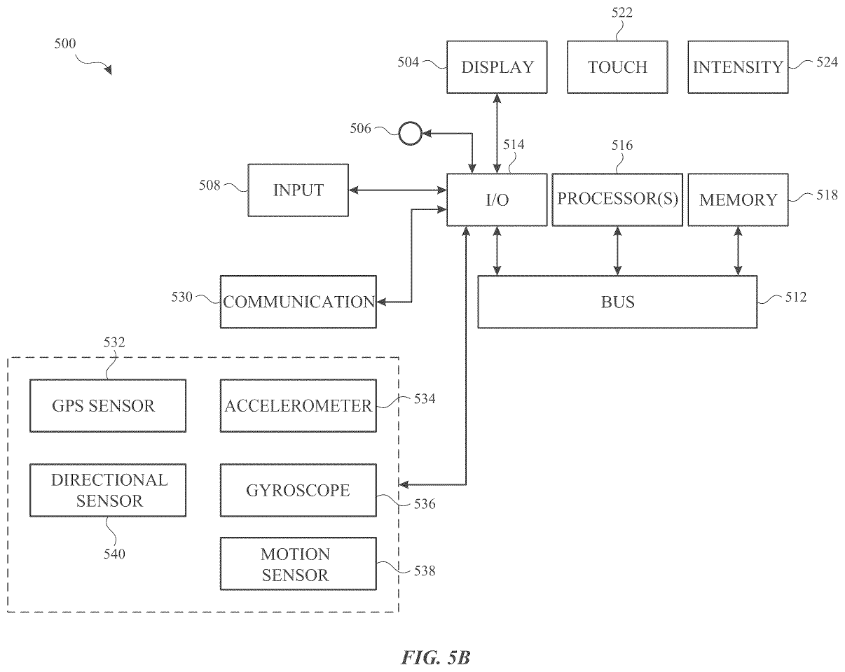

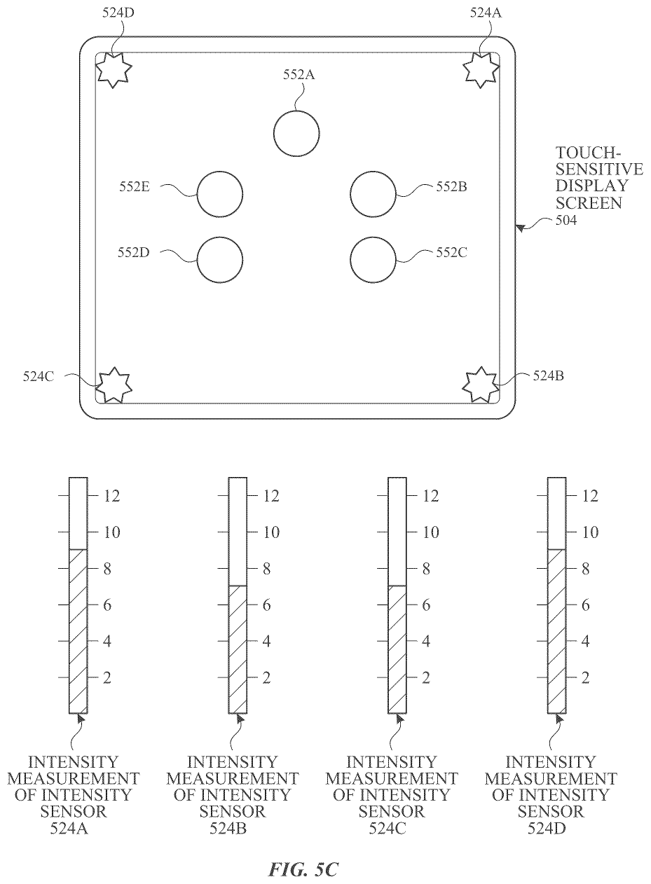

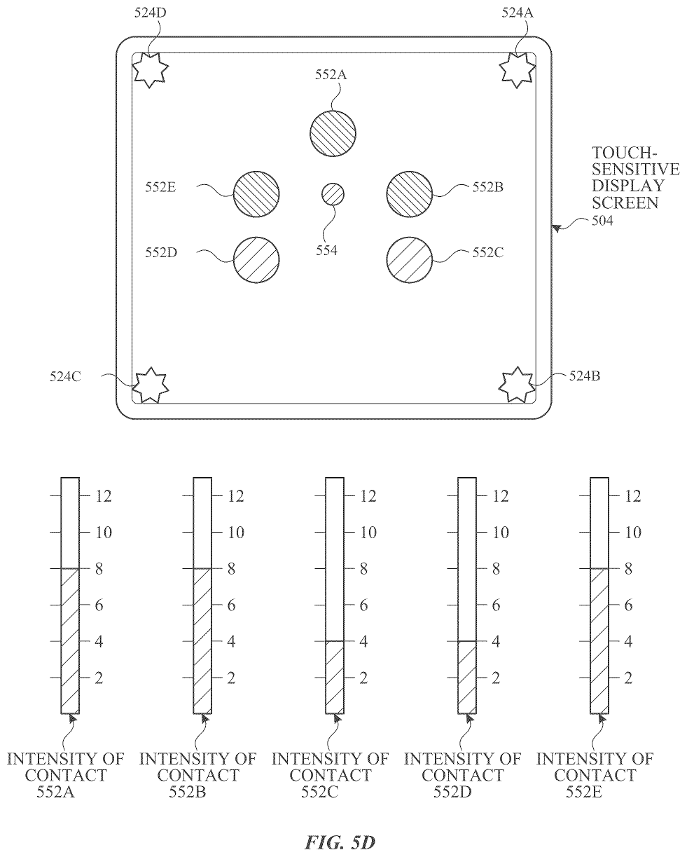

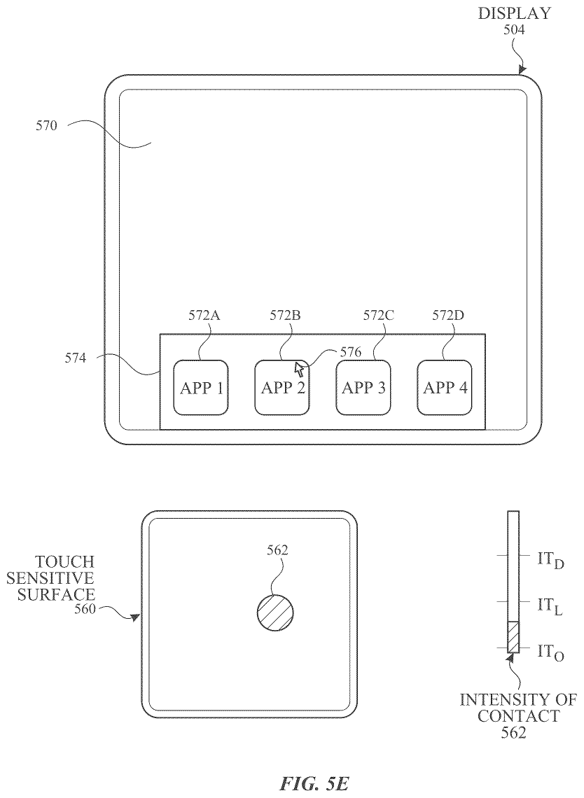

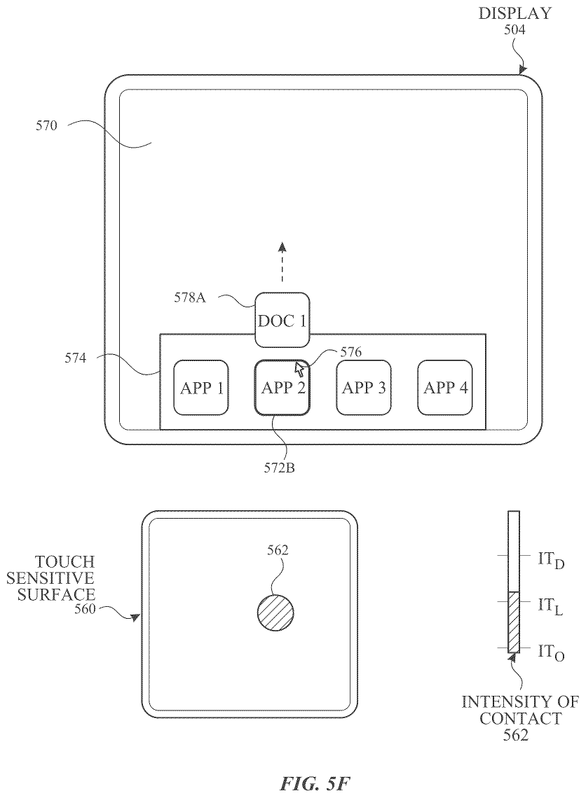

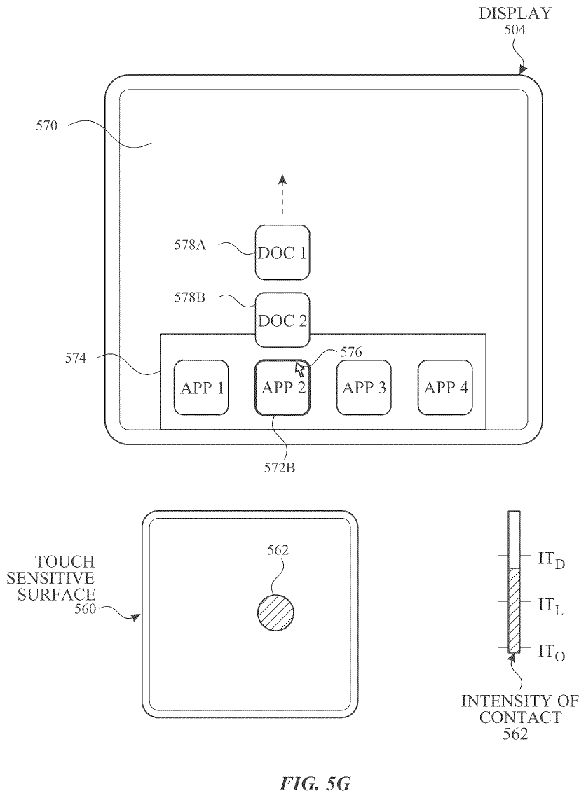

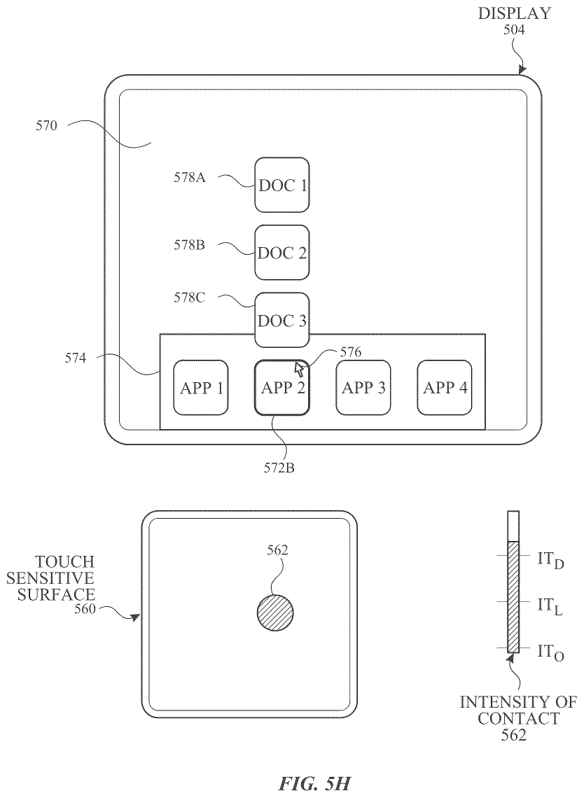

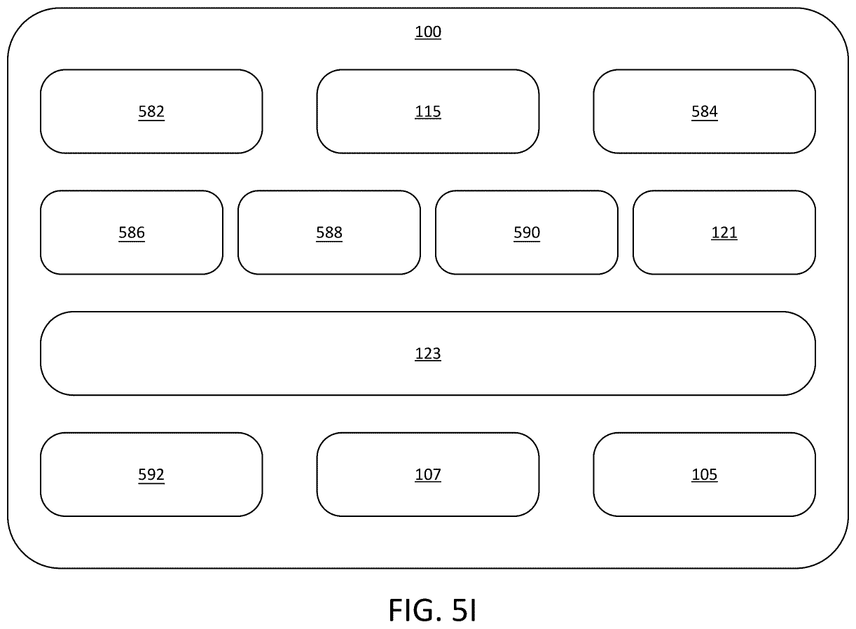

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 516 optionally execute any number of programs stored in memory 506 or storage, which optionally includes instructions to perform one or more of the methods and/or processes described herein (e.g., methods 700 and/or 900). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIGS. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “ITL”) in FIG. 5E, to an intensity above a deep press intensity threshold (e.g., “ITD”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “ITD”). Contact 562 is maintained on touch-sensitive surface 560. In response to the detection of the gesture, and in accordance with contact 562 having an intensity that goes above the deep press intensity threshold (e.g., “ITD”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “ITD”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as device 100, device 300, or device 500.

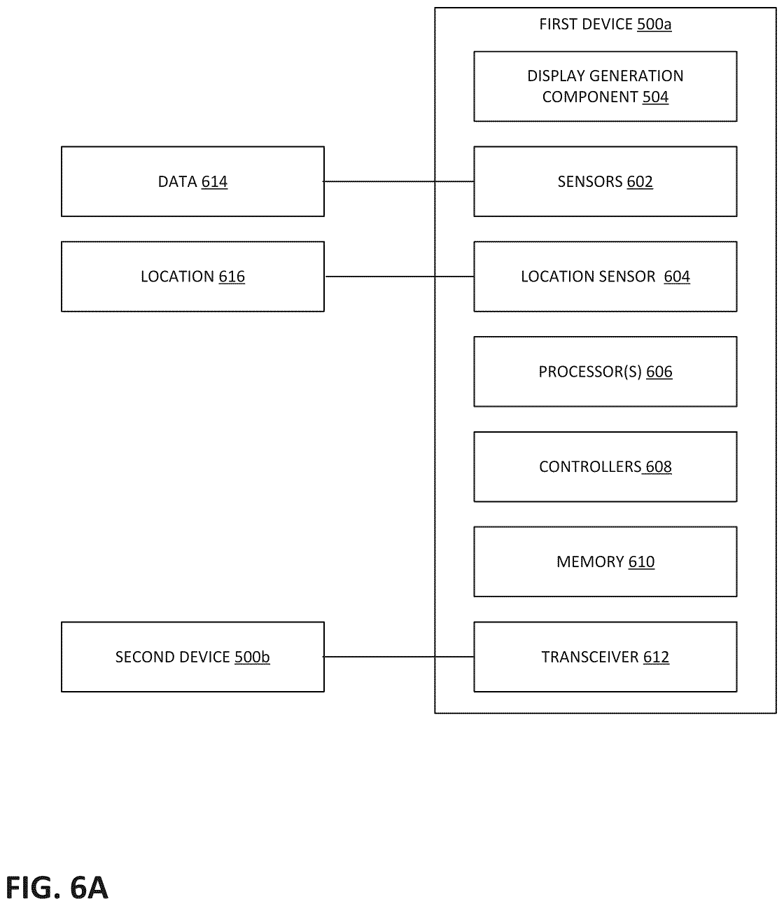

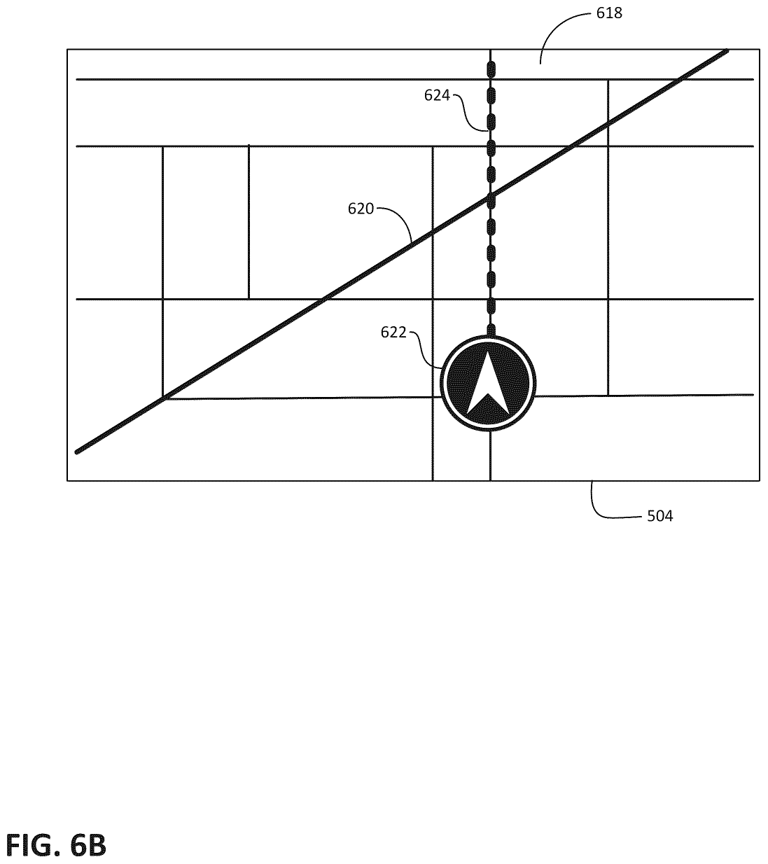

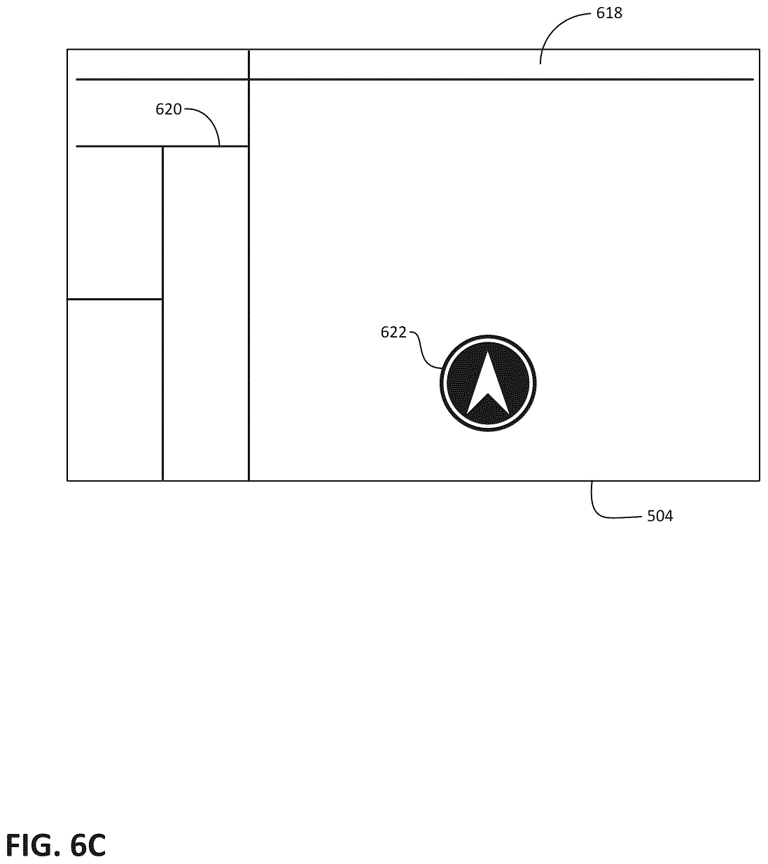

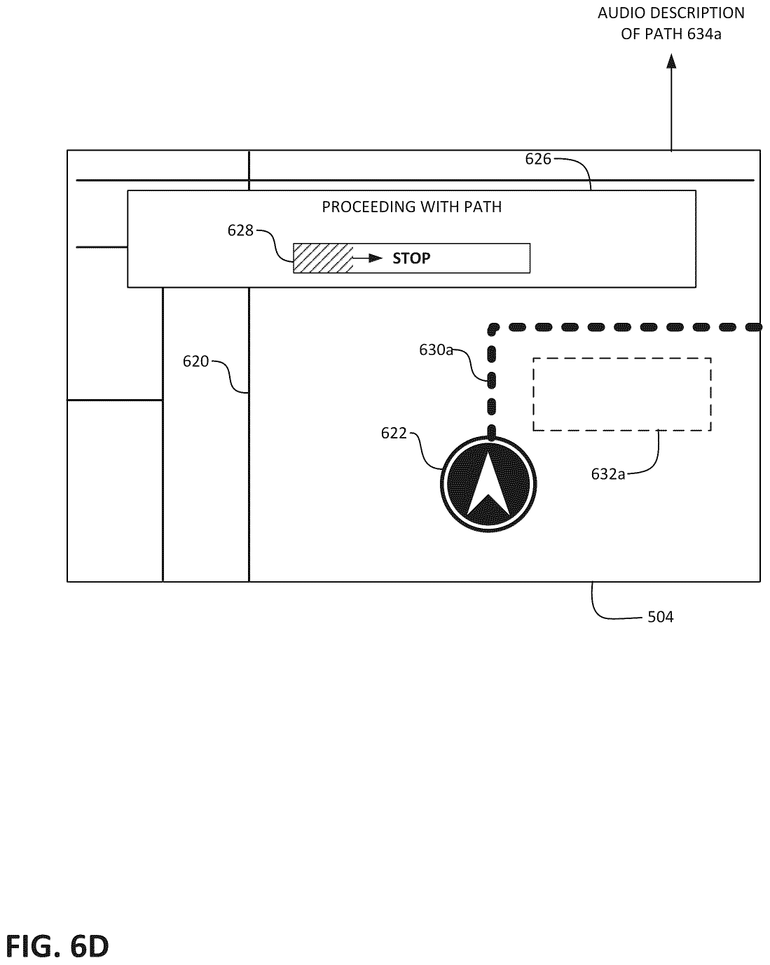

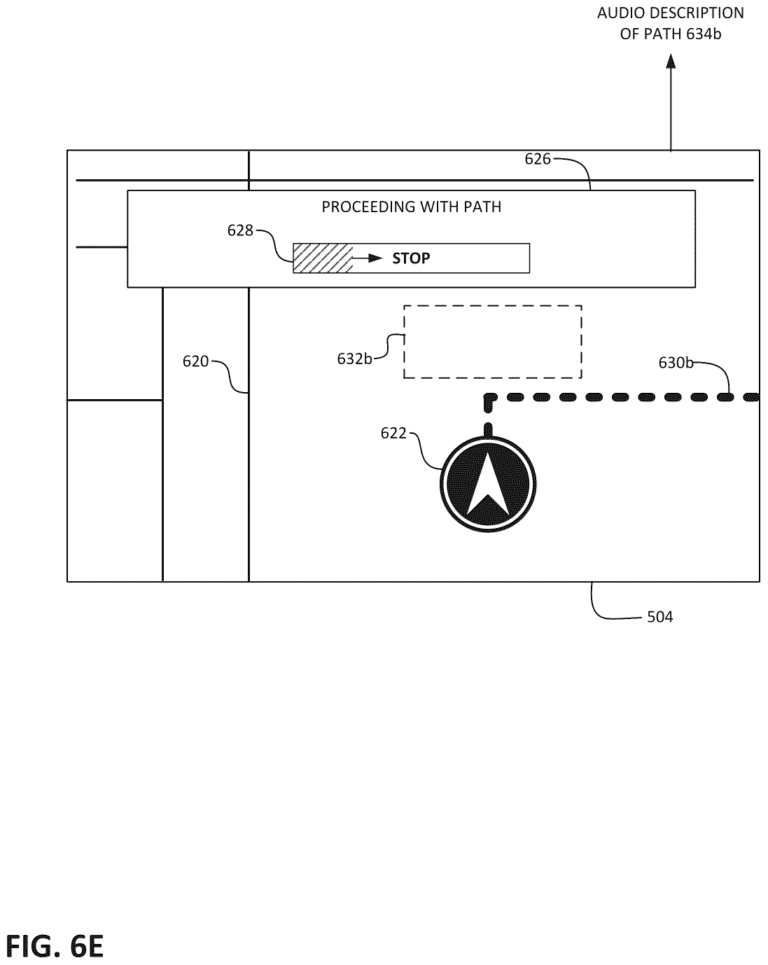

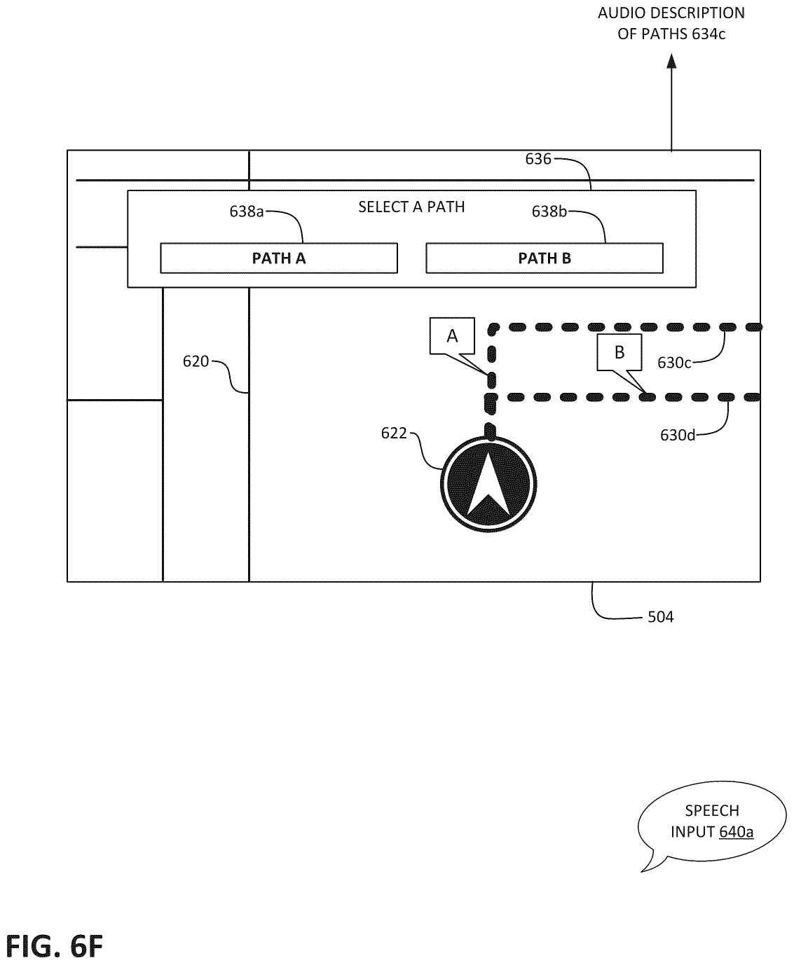

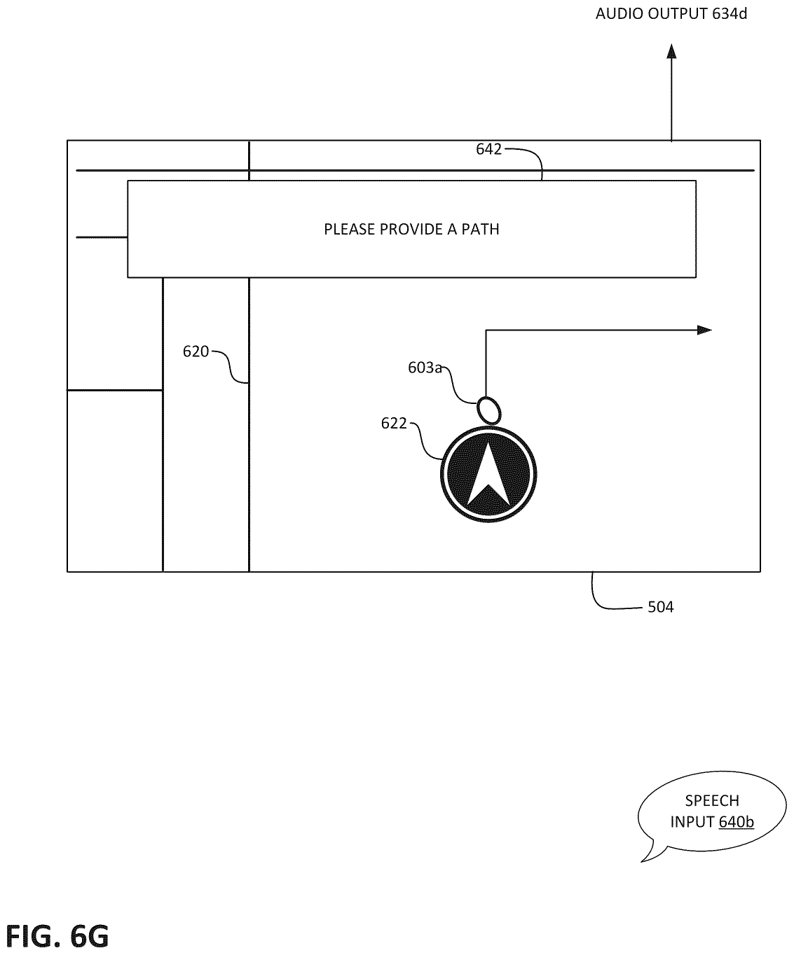

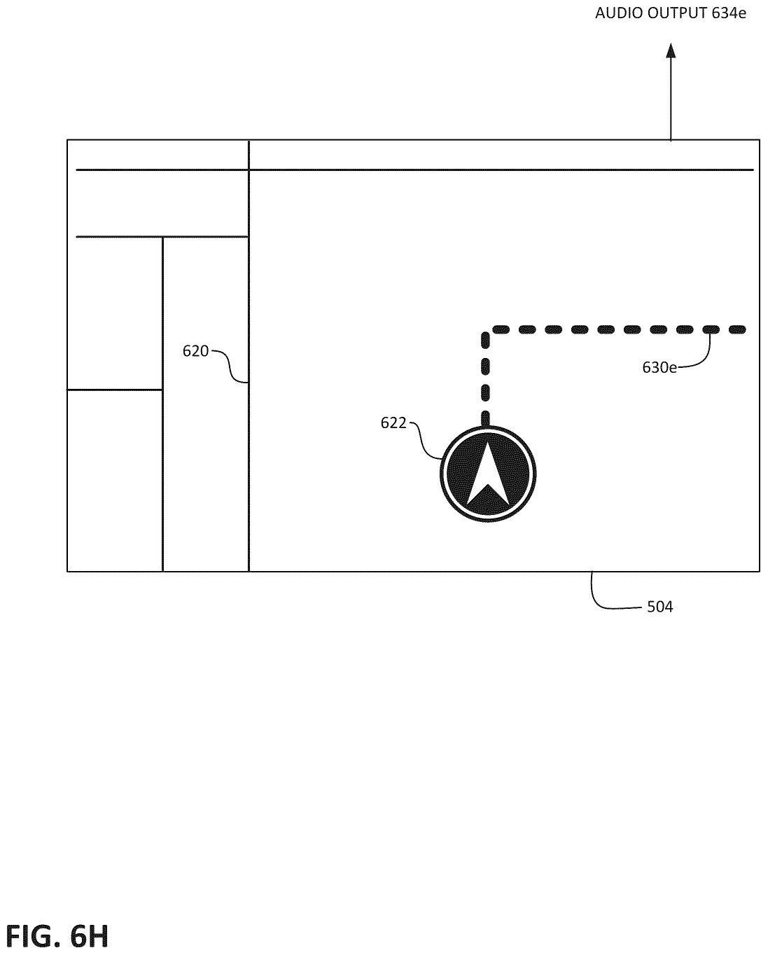

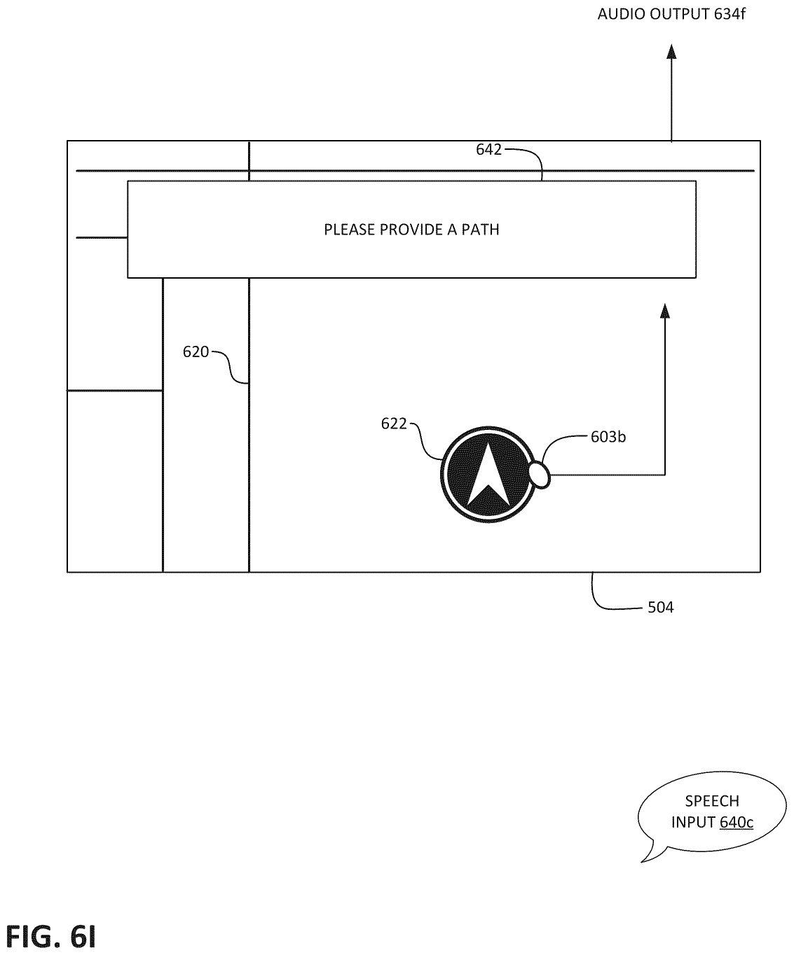

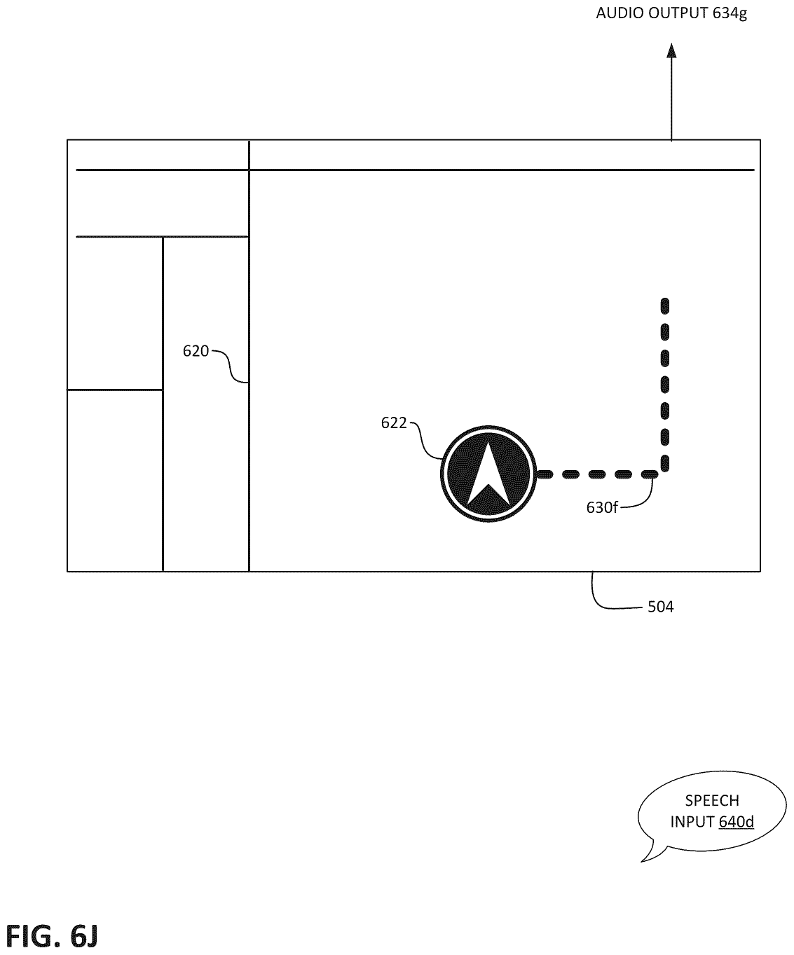

FIG. 5I provides illustrations of exemplary devices for performing techniques for impromptu paths. FIGS. 6A-6J illustrate exemplary user interfaces for impromptu paths in accordance with some embodiments. FIG. 7 is a flow diagram illustrating methods of impromptu paths in accordance with some embodiments. The user interfaces in FIGS. 6A-6J are used to illustrate the processes described below, including the processes in FIG. 7.

The processes below describe various techniques for making user interfaces and/or human-computer interactions more efficient (e.g., by helping the user to quickly and easily provide inputs and preventing user mistakes when operating a device). These techniques sometimes reduce the number of inputs needed for a user (e.g., a person and/or a user) to perform an operation, provide clear and/or meaningful feedback (e.g., visual, acoustic, and/or haptic feedback) to the user so that the user knows what has happened or what to expect, provide additional information and controls without cluttering the user interface, and/or perform certain operations without requiring further input from the user. Since the user can use a device more quickly and easily, these techniques sometimes improve battery life and/or reduce power usage of the device.

In methods described where one or more steps are contingent on one or more conditions having been satisfied, it should be understood that the described method can be repeated in multiple repetitions so that over the course of the repetitions all of the conditions upon which steps in the method are contingent have been satisfied in different repetitions of the method. For example, if a method requires performing a first step if a condition is satisfied, and a second step if the condition is not satisfied, it should be appreciated that the steps are repeated until the condition has been both satisfied and not satisfied, in no particular order. Thus, a method described with one or more steps that are contingent upon one or more conditions having been satisfied could be rewritten as a method that is repeated until each of the conditions described in the method has been satisfied. This multiple repetition, however, is not required of system or computer readable medium claims where the system or computer readable medium contains instructions for performing conditional operations that require that one or more conditions be satisfied before the operations occur. A person having ordinary skill in the art would also understand that, similar to a method with conditional steps, a system or computer readable storage medium can repeat the steps of a method as many times as are needed to ensure that all of the conditional steps have been performed.

The terminology used in the description of the various embodiments is for the purpose of describing particular embodiments only and is not intended to be limiting.

User interfaces for electronic devices, and associated processes for using these devices, are described below. In some embodiments, the device is a desktop computer with a touch-sensitive surface (e.g., a touch screen display and/or a touchpad). In other embodiments, the device is a portable, movable, and/or mobile electronic device (e.g., a processor, a smart phone, a smart watch, a tablet, a fitness tracking device, a laptop, a head-mounted display (HMD) device, a communal device, a vehicle, a media device, a smart speaker, a smart display, a robot, a television and/or a personal computing device).

In some embodiments, the electronic device is a computer system that is in communication with a display component (e.g., by wireless or wired communication). The display component may be integrated into the computer system or may be separate from the computer system. Additionally, the display component may be configured to provide visual output to a display (e.g., a liquid crystal display, an OLED display, or CRT display). As used herein, “displaying” content includes causing to display the content (e.g., video data rendered or decoded by a display controller) by transmitting, via a wired or wireless connection, data (e.g., image data or video data) to an integrated or external display component to visually produce the content. In some embodiments, visual output is any output that is capable of being perceived by the human eye, including, and not limited to images, videos, graphs, charts, and other graphical representations of data.

In some embodiments, the electronic device is a computer system that is in communication with an audio generation component (e.g., by wireless or wired communication). The audio generation component may be integrated into the computer system or may be separate from the computer system. Additionally, the audio generation component may be configured to provide audio output. Examples of an audio generation component include a speaker, a home theater system, a soundbar, a headphone, an earphone, an earbud, a television speaker, an augmented reality headset speaker, an audio jack, an optical audio output, a Bluetooth audio output, and/or an HDMI audio output). In some embodiments, audio output is any output that is capable of being perceived by the human ear, including, and not limited to sound waves, music, speech, and/or other audible representations of data.

In the discussion that follows, an electronic device that includes particular input and output devices is described. It should be understood, however, that the electronic device optionally includes one or more other input and/or output devices, such as physical user-interface devices (e.g., a physical keyboard, a mouse, and/or a joystick).

FIG. 5I illustrates an example system 100 for implementing techniques described herein. System 100 can perform any of the methods described in FIG. 7 (e.g., method 700) and/or portions of this method.

In FIG. 5I, system 100 includes various components, such as processor(s) 592, RF circuitry(ies) 105, memory(ies) 107, sensors 586 (e.g., image sensor(s), orientation sensor(s), location sensor(s), heart rate monitor(s), temperature sensor(s)), input component(s) 588 (e.g., camera(s) (e.g., a periscope camera, a telephoto camera, a wide-angle camera, and/or an ultra-wide-angle camera), depth sensor(s), microphone(s), touch sensitive surface(s), hardware input mechanism(s), and/or rotatable input mechanism(s)), mobility components (e.g., actuator(s) (e.g., pneumatic actuator(s), hydraulic actuator(s), and/or electric actuator(s)), motor(s), wheel(s), movable base(s), rotatable component(s), translation component(s), and/or rotatable base(s)) and output component(s) 590 (e.g., speaker(s), display component(s), audio generation component(s), haptic output device(s), display screen(s), projector(s), and/or touch-sensitive display(s)). These components optionally communicate over communication bus(es) 123 of the system. Although shown as separate components, in some implementations, various components can be combined and function as a single component, such as a sensor can be an input component.

In some embodiments, system 100 is a mobile and/or movable device (e.g., a tablet, a smart phone, a laptop, head-mounted display (HMD) device, and or a smartwatch). In other embodiments, system 100 is a desktop computer, an embedded computer, and/or a server.

In some embodiments, processor(s) 592 includes one or more general processors, one or more graphics processors, and/or one or more digital signal processors. In some embodiments, memory (ies) 107 is one or more non-transitory computer-readable storage mediums (e.g., flash memory and/or random-access memory) that store computer-readable instructions configured to be executed by processor(s) 592 to perform techniques described herein.

In some embodiments, RF circuitry (ies) 105 includes circuitry for communicating with electronic devices and/or networks (e.g., the Internet, intranets, and/or a wireless network, such as cellular networks and wireless local area networks (LANs)). In some embodiments, RF circuitry (ies) 105 includes circuitry for communicating using near-field communication and/or short-range communication, such as Bluetooth® or Ultra-wideband.

In some embodiments, display(s) 121 includes one or more monitors, projectors, and/or screens. In some embodiments, display(s) 121 includes a first display for displaying images to a first eye of a user and a second display for displaying images to a second eye of the user. In such embodiments, corresponding images can be simultaneously displayed on the first display and the second display. Optionally, the corresponding images include the same virtual objects and/or representations of the same physical objects from different viewpoints, resulting in a parallax effect that provides the user with the illusion of depth of the objects on the displays. In some embodiments, display(s) 121 is a single display. In such embodiments, corresponding images are simultaneously displayed in a first area and a second area of the single display for each eye of the user. Optionally, the corresponding images include the same virtual objects and/or representations of the same physical objects from different viewpoints, resulting in a parallax effect that provides a user with the illusion of depth of the objects on the single display.

In some embodiments, system 100 includes touch-sensitive surface(s) 115 for receiving user inputs, such as tap inputs and swipe inputs. In some embodiments, display(s) 121 and touch-sensitive surface(s) 115 form touch-sensitive display(s).

In some embodiments, sensor(s) 586 includes sensors for detecting various conditions. In some embodiments, sensor(s) 586 includes orientation sensors (e.g., orientation sensor(s) 111) for detecting orientation and/or movement of platform 150. For example, system 100 uses orientation sensors to track changes in the location and/or orientation (sometimes collectively referred to as position) of system 100, such as with respect to physical objects in the physical environment. In some embodiments, sensor(s) 586 includes one or more gyroscopes, one or more inertial measurement units, and/or one or more accelerometers. In some embodiments, sensor(s) 586 includes a global positioning sensor (GPS) for detecting a GPS location of platform 150. In some embodiments, sensor(s) 586 includes a radar system, LIDAR system, sonar system, image sensors (e.g., image sensor(s) 109, visible light image sensor(s), and/or infrared sensor(s)), depth sensor(s), rangefinder(s), and/or motion detector(s). In some embodiments, sensor(s) 586 includes sensors that are in an interior portion of system 100 and/or sensors that are on an exterior of system 100. In some embodiments, system 100 uses sensor(s) 586 (e.g., interior sensors) to detect a presence and/or state (e.g., location and/or orientation) of a passenger in the interior portion of system 100. In some embodiments, system 100 uses sensor(s) 586 (e.g., external sensors) to detect a presence and/or state of an object external to system 100. In some embodiments, system 100 uses sensor(s) 586 to receive user inputs, such as hand gestures and/or other air gesture. In some embodiments, system 100 uses sensor(s) 586 to detect the location and/or orientation of system 100 in the physical environment. In some embodiments, system 100 uses sensor(s) 586 to navigate system 100 along a planned route, around obstacles, and/or to a destination location. In some embodiments, sensor(s) 586 include one or more sensors for identifying and/or authenticating a user of system 100, such as a fingerprint sensor and/or facial recognition sensor.

In some embodiments, image sensor(s) includes one or more visible light image sensor, such as charged coupled device (CCD) sensors, and/or complementary metal-oxide-semiconductor (CMOS) sensors operable to obtain images of physical objects. In some embodiments, image sensor(s) includes one or more infrared (IR) sensor(s), such as a passive IR sensor or an active IR sensor, for detecting infrared light. For example, an active IR sensor can include an IR emitter, such as an IR dot emitter, for emitting infrared light. In some embodiments, image sensor(s) includes one or more camera(s) configured to capture movement of physical objects. In some embodiments, image sensor(s) includes one or more depth sensor(s) configured to detect the distance of physical objects from system 100. In some embodiments, system 100 uses CCD sensors, cameras, and depth sensors in combination to detect the physical environment around system 100. In some embodiments, image sensor(s) includes a first image sensor and a second image sensor different form the first image sensor. In some embodiments, system 100 uses image sensor(s) to receive user inputs, such as hand gestures and/or other air gestures. In some embodiments, system 100 uses image sensor(s) to detect the location and/or orientation of system 100 in the physical environment.

In some embodiments, system 100 uses orientation sensor(s) for detecting orientation and/or movement of system 100. For example, system 100 can use orientation sensor(s) to track changes in the location and/or orientation of system 100, such as with respect to physical objects in the physical environment. In some embodiments, orientation sensor(s) includes one or more gyroscopes, one or more inertial measurement units, and/or one or more accelerometers.

In some embodiments, system 100 uses microphone(s) to detect sound from one or more users and/or the physical environment of the one or more users. In some embodiments, microphone(s) includes an array of microphones (including a plurality of microphones) that optionally operate in tandem, such as to identify ambient noise or to locate the source of sound in space (e.g., inside system 100 and/or outside of system 100) of the physical environment.

In some embodiments, input device(s) 588 includes one or more mechanical and/or electrical devices for detecting input, such as button(s), slider(s), knob(s), switch(es), remote control(s), joystick(s), touch-sensitive surface(s), keypad(s), microphone(s), and/or camera(s). In some embodiments, input device(s) 588 include one or more input devices inside system 100. In some embodiments, input device(s) 588 include one or more input devices (e.g., a touch-sensitive surface and/or keypad) on an exterior of system 100.

In some embodiments, output device(s) 590 include one or more devices, such as display(s), monitor(s), projector(s), speaker(s), light(s), and/or haptic output device(s). In some embodiments, output device(s) 590 includes one or more external output devices, such as external display screen(s), external light(s), and/or external speaker(s). In some embodiments, output device(s) 590 includes one or more internal output devices, such as internal display screen(s), internal light(s), and/or internal speaker(s).

In some embodiments, environment controls 584 includes mechanical and/or electrical systems for monitoring and/or controlling conditions of an internal portion (e.g., cabin) of system 100. In some embodiments, environmental controls 584 includes fan(s), heater(s), air conditioner(s), and/or thermostat(s) for controlling the temperature and/or airflow within the interior portion of system 100.

In some embodiments, mobility component(s) includes mechanical and/or electrical components that enable a platform to move and/or assist in the movement of the platform. In some embodiments, mobility system 582 includes powertrain(s), drivetrain(s), motor(s) (e.g., an electrical motor), engine(s), power source(s) (e.g., battery (ies)), transmission(s), suspension system(s), speed control system(s), and/or steering system(s). In some embodiments, one or more elements of mobility component(s) are configured to be controlled autonomously or manually (e.g., via system 100 and/or input device(s) 588).

In some embodiments, system 100 performs monetary transactions with or without another computer system. For example, system 100, or another computer system associated with and/or in communication with system 100 (e.g., via a user account described below), is associated with a payment account of a user, such as a credit card account or a checking account. To complete a transaction, system 100 can transmit a key to an entity from which goods and/or services are being purchased that enables the entity to charge the payment account for the transaction. As another example, system 100 stores encrypted payment account information and transmits this information to entities from which goods and/or services are being purchased to complete transactions.

System 100 optionally conducts other transactions with other systems, computers, and/or devices. For example, system 100 conducts transactions to unlock another system, computer, and/or device and/or to be unlocked by another system, computer, and/or device. Unlocking transactions optionally include sending and/or receiving one or more secure cryptographic keys using, for example, RF circuitry (ies) 105.

In some embodiments, system 100 is capable of communicating with other computer systems and/or electronic devices. For example, system 100 can use RF circuitry (ies) 105 to access a network connection that enables transmission of data between systems for the purpose of communication. Example communication sessions include phone calls, e-mails, SMS messages, and/or videoconferencing communication sessions.

In some embodiments, videoconferencing communication sessions include transmission and/or receipt of video and/or audio data between systems participating in the videoconferencing communication sessions, including system 100. In some embodiments, system 100 captures video and/or audio content using sensor(s) 586 to be transmitted to the other system(s) in the videoconferencing communication sessions using RF circuitry (ies) 105. In some embodiments, system 100 receives, using the RF circuitry (ies) 105, video and/or audio from the other system(s) in the videoconferencing communication sessions, and presents the video and/or audio using output component(s) 590, such as display(s) 121 and/or speaker(s). In some embodiments, the transmission of audio and/or video between systems is near real-time, such as being presented to the other system(s) with a delay of less than 0.1, 0.5, 1, or 3 seconds from the time of capturing a respective portion of the audio and/or video.

In some embodiments, the system 100 generates tactile (e.g., haptic) outputs using output component(s) 590. In some embodiments, output component(s) 590 generates the tactile outputs by displacing a moveable mass relative to a neutral position. In some embodiments, tactile outputs are periodic in nature, optionally including frequency (ies) and/or amplitude(s) of movement in two or three dimensions. In some embodiments, system 100 generates a variety of different tactile outputs differing in frequency (ies), amplitude(s), and/or duration/number of cycle(s) of movement included. In some embodiments, tactile output pattern(s) includes a start buffer and/or an end buffer during which the movable mass gradually speeds up and/or slows down at the start and/or at the end of the tactile output, respectively.

In some embodiments, tactile outputs have a corresponding characteristic frequency that affects a “pitch” of a haptic sensation that a user feels. For example, higher frequency (ies) corresponds to faster movement(s) by the moveable mass whereas lower frequency (ies) corresponds to slower movement(s) by the moveable mass. In some embodiments, tactile outputs have a corresponding characteristic amplitude that affects a “strength” of the haptic sensation that the user feels. For example, higher amplitude(s) corresponds to movement over a greater distance by the moveable mass, whereas lower amplitude(s) corresponds to movement over a smaller distance by the moveable mass. In some embodiments, the “pitch” and/or “strength” of a tactile output varies over time.

In some embodiments, tactile outputs are distinct from movement of system 100. For example, system 100 can includes tactile output device(s) that move a moveable mass to generate tactile output and can include other moving part(s), such as motor(s), wheel(s), axel(s), control arm(s), and/or brakes that control movement of system 100. Although movement and/or cessation of movement of system 100 generates vibrations and/or other physical sensations in some situations, these vibrations and/or other physical sensations are distinct from tactile outputs. In some embodiments, system 100 generates tactile output independent from movement of system 100 For example, system 100 can generate a tactile output without accelerating, decelerating, and/or moving system 100 to a new position.

In some embodiments, system 100 detects gesture input(s) made by a user. In some embodiments, gesture input(s) includes touch gesture(s) and/or air gesture(s), as described herein. In some embodiments, touch-sensitive surface(s) 115 identify touch gestures based on contact patterns (e.g., different intensities, timings, and/or motions of objects touching or nearly touching touch-sensitive surface(s) 115). Thus, touch-sensitive surface(s) 115 detect a gesture by detecting a respective contact pattern. For example, detecting a finger-down event followed by detecting a finger-up (e.g., liftoff) event at (e.g., substantially) the same position as the finger-down event (e.g., at the position of a user interface element) can correspond to detecting a tap gesture on the user interface element. As another example, detecting a finger-down event followed by detecting movement of a contact, and subsequently followed by detecting a finger-up (e.g., liftoff) event can correspond to detecting a swipe gesture. Additional and/or alternative touch gestures are possible.

In some embodiments, an air gesture is a gesture that a user performs without touching input component(s) 588. In some embodiments, air gestures are based on detected motion of a portion (e.g., a hand, a finger, and/or a body) of a user through the air. In some embodiments, air gestures include motion of the portion of the user relative to a reference. Example references include a distance of a hand of a user relative to a physical object, such as the ground, an angle of an arm of the user relative to the physical object, and/or movement of a first portion (e.g., hand or finger) of the user relative to a second portion (e.g., shoulder, another hand, or another finger) of the user. In some embodiments, detecting an air gesture includes detecting absolute motion of the portion of the user, such as a tap gesture that includes movement of a hand in a predetermined pose by a predetermined amount and/or speed, or a shake gesture that includes a predetermined speed or amount of rotation of a portion of the user.

In some embodiments, detecting one or more inputs includes detecting speech of a user. In some embodiments, system 100 uses one or more microphones of input component(s) 588 to detect the user speaking one or more words. In some embodiments, system 100 parses and/or communicates information to one or more other systems to determine contents of the speech of the user, including identifying words and/or obtaining a semantic understanding of the words. For example, system processor(s) 592 can be configured to perform natural language processing to detect one or more words and/or determine a likely meaning of the one or more words in the sequence spoken by the user. Additionally or alternatively, in some embodiments, the system 100 determines the meaning of the one or more words in the sequence spoken based upon a context of the user determined by the system 100.

In some embodiments, system 100 outputs spatial audio via output component(s) 590. In some embodiments, spatial audio is output in a particular position. For example, system 100 can play a notification chime having one or more characteristics that cause the notification chime to be generated as if emanating from a first position relative to a current viewpoint of a user (e.g., “spatializing” and/or “spatialization” including audio being modified in amplitude, filtered, and/or delayed to provide a perceived spatial quality to the user).

In some embodiments, system 100 presents visual and/or audio feedback indicating a position of a user relative to a current viewpoint of another user, thereby informing the other user about an updated position of the user. In some embodiments, playing audio corresponding to a user includes changing one or more characteristics of audio obtained from another computer system to mimic an effect of placing an audio source that generates the play back of audio within a position corresponding to the user, such as a position within a three-dimensional environment that the user moves to, spawns at, and/or is assigned to. In some embodiments, a relative magnitude of audio at one or more frequencies and/or groups of frequencies is changed, one or more filters are applied to audio (e.g., directional audio filters), and/or the magnitude of audio provided via one or more channels are changed (e.g., increased or decreased) to create the perceived effect of the physical audio source. In some embodiments, the simulated position of the simulated audio source relative to a floor of the three-dimensional environment matches an elevation of a head of a participant providing audio that is generated by the simulated audio source, or is a predetermined one or more elevations relative to the floor of the three-dimensional environment. In some embodiments, in accordance with a determination that the position of the user will correspond to a second position, different from the first position, and that one or more first criteria are satisfied, system 100 presents feedback including generating audio as if emanating from the second position.

In some embodiments, system 100 communicates with one or more accessory devices. In some embodiments, one or more accessory devices is integrated with system 100. In some embodiments, one or more accessory devices is external to system 100. In some embodiments, system 100 communicates with accessory device(s) using RF circuitry (ies) 105 and/or using a wired connection. In some embodiments, system 100 controls operation of accessory device(s), such as door(s), window(s), lock(s), speaker(s), light(s), and/or camera(s). For example, system 100 can control operation of a motorized door of system 100. As another example, system 100 can control operation of a motorized window included in system 100. In some embodiments, accessory device(s), such as remote control(s) and/or other computer systems (e.g., smartphones, media players, tablets, computers, and/or wearable devices) functioning as input devices control operations of system 100. For example, a wearable device (e.g., a smart watch) functions as a key to initiate operation of an actuation system of system 100. In some embodiments, system 100 acts as an input device to control operations of another system, device, and/or computer, such as the platform 100 functioning as a key to initiate operation of an actuation system of a platform associated with another system, device, and/or computer.

In some embodiments, digital assistant(s) help a user perform various functions using system 100. For example, a digital assistant can provide weather updates, set alarms, and perform searches locally and/or using a network connection (e.g., the Internet) via a natural-language interface. In some embodiments, a digital assistant accepts requests at least partially in the form of natural language commands, narratives, requests, statements, and/or inquiries. In some embodiments, a user requests an informational answer and/or performance of a task using the digital assistant. For example, in response to receiving the question “What is the current temperature?,” the digital assistant answers “It is 30 degrees.” As another example, in response to receiving a request to perform a task, such as “Please invite my family to dinner tomorrow,” the digital assistant can acknowledge the request by playing spoken words, such as “Yes, right away,” and then send the requested calendar invitation on behalf of the user to each family member of the user listed in a contacts list for the user. In some embodiments, during performance of a task requested by the user, the digital assistant engages with the user in a sustained conversation involving multiple exchanges of information over a period of time. Other ways of interacting with a digital assistant are possible to request performance of a task and/or request information. For example, the digital assistant can respond to the user in other forms, e.g., displayed alerts, text, videos, animations, music, etc. In some embodiments, the digital assistant includes a client-side portion executed on system 100 and a server-side portion executed on a server in communication with system 100. The client-side portion can communicate with the server through a network connection using RF circuitry (ies) 105. The client-side portion can provide client-side functionalities, input and/or output processing and/or communication with the server, for example. In some embodiments, the server-side portion provides server-side functionalities for any number client-side portions of multiple systems.

In some embodiments, system 100 is associated with one or more user accounts. In some embodiments, system 100 saves and/or encrypts user data, including files, settings, and/or preferences in association with particular user accounts. In some embodiments, user accounts are password-protected and system 100 requires user authentication before accessing user data associated with an account. In some embodiments, user accounts are associated with other system(s), device(s), and/or server(s). In some embodiments, associating one user account with multiple systems enables those systems to access, update, and/or synchronize user data associated with the user account. For example, the systems associated with a user account can have access to purchased media content, a contacts list, communication sessions, payment information, saved passwords, and other user data. Thus, in some embodiments, user accounts provide a secure mechanism for a customized user experience.

Users interact with electronic devices in many different manners, including for transportation. In some embodiments, an electronic device navigates or travels from a starting location to a destination using predetermined paths included in map and/or, in areas where predetermined paths are not available, paths determined (or partially determined) by the electronic device. The embodiments described below provide ways in which an electronic device navigates or travels on paths other than predetermined paths (e.g., paths included in a map and/or paths designated with lane markings).

FIGS. 6A-6J illustrate exemplary ways in which an electronic device navigates or travels on predetermined paths and/or impromptu paths according to some embodiments of the disclosure. The embodiments in these figures are used to illustrate the processes described below, including the processes described with reference to FIG. 7. Although FIGS. 6A-6J illustrate various examples of ways an electronic device is able to perform the processes described below with reference to FIG. 7, it should be understood that these examples are not meant to be limiting, and the electronic device is able to perform one or more processes described below with reference to FIG. 7 in ways not expressly described with reference to FIGS. 6A-6J.

FIG. 6A illustrates a block diagram of a first electronic device 500a operating in environment 600. In some embodiments, the electronic device 500a is in communication with (e.g., includes) a display component 504, sensors 602, location sensor 604, processor(s) 606, controllers 608, memory 610, and transceiver 612.

In some embodiments, sensors 602 include camera(s), range sensor(s), accelerometer(s), speedometer(s), and/or thermometer(s). In some embodiments, the electronic device 500a uses sensors 602 to sense data 614 corresponding to the environment 600 of the first device 500a. As described in more detail below, for example, the electronic device 500a uses the data 614 to generate impromptu paths for navigation in areas that do not include predetermined paths based on various characteristics of the environment 600.

In some embodiments, the location sensor 604 is a GPS (global positioning satellite) or other satellite-based navigation unit configured to sense a location 616 of the electronic device 500a. In some embodiments, the electronic device 500a uses the location sensor 604 to navigate along predetermined paths included in map information and to determine whether or not predetermined paths are available at the starting location 616 of the electronic device 500a.

In some embodiments, the one or more controllers 608 control subsystems of the electronic device 500a and/or other devices in communication with the electronic device 500a, such as the second electronic device 500b and/or a vehicle in communication with the electronic device 500a. For example, the one or more controllers 608 control actuators of a vehicle, such as an engine or motor, brakes, steering, lights, windows, doors, climate control, and/or media playback. In some embodiments, navigating along predetermined paths and/or impromptu paths includes autonomous driving and/or driver assistance functions controlled by controllers 608. In some embodiments, navigating along predetermined paths and/or impromptu paths includes presenting navigation directions to the user while the user drives a vehicle.

In some embodiments, the electronic device 500a uses memory 610 to store instructions for executing the methods disclosed herein and/or to store map or path information.

In some embodiments, the electronic device 500a uses transceiver 612 to communicate with a second electronic device 500b. In some embodiments, the electronic device 500a communicates with multiple second electronic devices 500b. For example, the electronic device 500a communicates with vehicles in the environment 600 of the electronic device 500a, a maps server, other devices associated with the user account of the electronic device 500a, and/or electronic devices associated with the starting location 616 of the electronic device 500a. In some embodiments, the electronic device 500a obtains information from the second electronic device 500b that the electronic device 500a uses to generate and/or select impromptu paths, as described in more detail below.

FIG. 6B illustrates an example maps user interface 618 optionally displayed by the electronic device 500a while navigating to a destination. In some embodiments, the electronic device 500a displays the maps user interface 618 using a display component 504 while navigating to the destination. In some embodiments, the electronic device 500a forgoes display of the maps user interface 618 while navigating to the destination. In some embodiments, additionally or alternatively, the electronic device 500a outputs an audio user interface including the map information corresponding to the maps user interface 618 illustrated in FIG. 6B. For example, in some embodiments, the electronic device 500a forgoes display of the graphical user interface in FIG. 6B, and the graphical user interface in FIG. 6B represents the current position 622 of the electronic device relative to predetermined paths 620 and the navigation path 624 in the environment of the electronic device.

In some embodiments, the maps user interface 618 represents a physical region including the starting location of the electronic device 500a. As shown in FIG. 6B, the maps user interface 618 includes indications 620 of predetermined paths included in map information accessible to the electronic device 500a, an indication 622 of the starting location of the electronic device 500a, and an indication 624 of the path the electronic device 500a is navigating. In some embodiments, predetermined paths include paths included in public map data, paths marked with lane markings and/or road signs, such as streets, highways, toll roads, bridges, bike paths, roads differentiated from their surroundings based on the surface material of the road, hiking trails, tunnels, driveways, and/or walking paths. For example, in FIG. 6B, the path the electronic device 500a is navigating is a predetermined path, so the indication 624 of the path of the electronic device 500a is overlaid on an indication of a predetermined path. In some embodiments, the audio maps user interface includes an audio description of the map information corresponding to the physical region including the starting location of the electronic device 500a, such as the roads and landmarks in the region including the electronic device 500a. In some embodiments, the audio maps user interface includes an audio description of the path the electronic device 500a is navigating.

FIG. 6C illustrates an example maps user interface 618 optionally displayed by the electronic device 500a including a location that does not include predetermined paths. For example, the starting location of the electronic device 500a does not include roads and/or highways or other map information for the electronic device 500a to use in determining navigation from an originating point to a destination point. In some embodiments, while navigating to a destination and while the electronic device 500a is in a location without predetermined paths or other map information, the electronic device 500a generates an impromptu path according to method 700. In some embodiments, a user may input a path (e.g., sketch a path on a user interface from one point to another) which the electronic device 500a may use to navigate. In some embodiments, the impromptu path is from an originating location of the electronic device 500a to a an intermediate location in the direction of the destination and/or a location that is the navigation destination itself. In some embodiments, the impromptu path is from the starting location of the electronic device 500a to a predetermined path included on the route to a destination. For example, the electronic device 500 uses an impromptu path to move from a temporary parking lot on a field that does not include predetermined paths to a road included in map data accessible to the electronic device 500. In this example, once on the road, the electronic device 500 navigates to a destination using the road and optionally one or more additional predetermined paths included in the map information. As another example, the electronic device 500 uses an impromptu path in a wilderness area that does not include predetermined paths in the map information, such as traveling within a campsite. The impromptu path can be included at the beginning, end, or somewhere between the beginning or end of navigating from an origin location to a destination location. In some embodiments, the electronic device 500a displays the map of the area without predetermined paths while the electronic device 500a is in a different location. For example, the user of the electronic device 500a uses electronic device 500a to plan, browse, and/or share impromptu paths that can be used in the future by the electronic device 500a and/or by a different device. In some embodiments, the electronic device 500a forgoes display of the graphical user interface in FIG. 6C, and the graphical user interface in FIG. 6C represents the current position 622 of the electronic device relative to predetermined paths 620 in the environment of the electronic device.

In some embodiments, in response to detecting that a location of or to which the electronic device 500a is navigating does not include a predetermined path, the electronic device 500a generates one or more possible impromptu paths to the destination. In some situations, the electronic device 500a prompts the user to provide an input selecting or creating the impromptu path, as described in more detail below with reference to FIGS. 6D-6J. In some embodiments, the electronic device 500a requests different amounts of feedback from the user depending on a level of confidence the electronic device 500a has that one or more predetermined paths generated by the electronic device 500a are appropriate for reaching the destination. In some embodiments, the electronic device 500a generates and/or evaluates the possible paths using one or more of machine learning, scene understanding, computer vision, and/or algorithmic techniques.

In some embodiments, the electronic device 500a uses a plurality of factors and/or criteria, optionally with different weights, to generate and/or evaluate impromptu paths for use in navigating areas without predetermined paths. Examples of these factors include:
the size of a vehicle in communication with the electronic device 500a that is navigating to the destination and the size of the environment of the vehicle;
weather conditions at the starting location or forecasted when the journey is to be taken of the electronic device 500a;
impromptu paths previously used by the user of the electronic device 500a, a vehicle in communication with the electronic device 500a, or another electronic device;
information provided by a manager of a location included in the impromptu path;
directions provided by a human in the environment of the electronic device 500a;
the behavior of vehicles in the environment of the electronic device 500a;
the presence and/or arrangement of temporary traffic objects, such as cones, traffic signs, temporary road closures or detours, and/or law enforcement in the environment of the electronic device 500a; and/or
the type of environment in which the electronic device 500a is currently located or will be located in based on navigation directions, a navigation destination, and/or a travel itinerary;
user preferences.

In some embodiments, the electronic device 500a generates impromptu paths based on one or more of the factors above. For example, if a respective factor has a first value, the electronic device 500a generates one or more first impromptu paths and if the respective factor has a second value different form the first value, the electronic device 500a generates one or more second impromptu paths different from the one or more first impromptu paths. For example, when the temperature of the physical environment of the electronic device 500a is above a threshold level (e.g., 25, 28, 30, 32, or 35 degrees Celsius), the one or more impromptu paths include the use of shaded areas of the physical environment more than would be the case when the temperature of the physical environment of the electronic device 500a is below the threshold temperature. Additional examples and additional details about these factors are described below with reference to method 700. In some embodiments, the electronic device 500a uses data 614 sensed using one or more sensors 602, location 616 data sensed by location sensor 604, and/or information provided by a second electronic device 500b to determine the substance of these factors.

Additionally or alternatively, in some examples, the electronic device 500a uses predetermined paths provided by another electronic device. In some embodiments, an electronic device associated with a geographic location provides impromptu paths for use in that location. For example, event organizers use an electronic device to provide impromptu paths for use in a temporary event parking lot. As another example, business owners use an electronic device to provide impromptu paths for use in a parking lot of the business. As another example, a property owner uses an electronic device to provide impromptu paths for use on their property. In some embodiments, the other electronic device transmits the impromptu paths to other devices, such as electronic device 500a, located in the area including the impromptu paths. As another example, the other electronic devices make the impromptu paths available to electronic devices, including electronic device 500a, viewing a map of the geographic area including the impromptu paths, regardless of the current location of the electronic device viewing the map.

FIG. 6D illustrates an example of the electronic device 500a outputting a user interface including a representation 630a of an impromptu path. In some embodiments, the electronic device 500a displays the user interface shown in FIG. 6D. Additionally or alternatively, in some embodiments, the electronic device 500a outputs an audio description 634a of the impromptu path. In some embodiments, the electronic device 500a presents the graphical user interface and/or audio 634a in FIG. 6D in accordance with relatively high confidence in the impromptu path.

As shown in FIG. 6D, the graphical user interface includes the indication 630a of the impromptu path, an indication 622 of a starting position of the electronic device 500a, and/or a prompt 626 indicating to the user that the electronic device 500a will proceed to navigate according to the impromptu path, optionally including autonomously driving along the impromptu path, after a predetermined time threshold unless the electronic device 500a receives a user input requesting that the electronic device 500a not navigate the impromptu path. As shown in FIG. 6D, the prompt 626 includes a selectable option 628 that, when selected, causes the electronic device 500a to forgo navigating the impromptu path. In some embodiments, the prompt 626 includes an animation with a duration equal to the predetermined time threshold to visually or otherwise indicate to the user the time remaining before the electronic device 500a proceeds to navigate according to the impromptu path. For example, the selectable option 628 is animated with shading that gradually fills in the selectable option 628 over the course of the predefined threshold amount of time.

In some embodiments, the electronic device 500a presents a user interface similar to FIG. 6D in a context other than planning imminent travel along the impromptu path 630a. For example, the electronic device 500a displays the user interface in a context of viewing, planning, sharing, and/or saving impromptu paths for future use by the electronic device 500a and/or by a different electronic device. For example, in the context other than imminent travel, the electronic device 500a forgoes displaying prompt 626 and the electronic device 500a does not initiate travel along the impromptu path 630a in the absence of receiving an input within a time threshold. In some embodiments, outside of the context of imminent travel, the starting position 622 may be different from a current location of the electronic device 500a. For example, the electronic device 500a uses a location selected by the user as the starting position 622 independent from the current location of the electronic device 500a.

In some embodiments, the electronic device 500a generates the impromptu path based on one or more of the factors listed above and described in more detail below with respect to method 700. Additionally or alternatively, in some embodiments, the electronic device 500a senses an object 632a in the environment of the electronic device 500a and generates the impromptu path at least partially based on avoiding collision with the object 632a. In some embodiments, object 632a is included in FIG. 6D for illustrative purposes and, in some embodiments, the electronic device 500a does not display a representation of the object 632a in the user interface if the object 632a is not included in the map data.

In some embodiments, the electronic device 500a senses objects in the environment of the electronic device 500a and updates the map data to include information about the size, shape, and/or location of the objects in accordance with a determination that the objects satisfy one or more criteria. For example, the electronic device 500a updates the map data to include objects that are more likely to remain at their current locations than they are to move from their current locations, such as buildings, walls, curbs, and other long-term objects. In some embodiments, the electronic device 500a forgoes updating the map data to include information about objects that do not satisfy the one or more criteria. For example, the electronic device 500a does not update the map data to include information about objects that are more likely to move from their current locations than they are to remain at their current locations, such as vehicles, people, animals, temporary traffic objects, and other short-term objects. In some embodiments, the electronic device 500a generates impromptu paths that avoid collisions with objects regardless of whether or not the electronic device 500a updates the map information to include information about the objects.

In some embodiments, when detecting objects, the electronic device 500a detects a moving object, such as a person, animal, or vehicle. In some embodiments, the electronic device 500a tracks the movement of the object to predict future movement and/or a future location of an object to avoid a collision with an object that appears likely to move into the upcoming path of the electronic device 500a. For example, if the electronic device 500a detects a person moving towards a road the electronic device 500a is navigating, then no longer detects the person because the person moved behind another object, the electronic device 500a predicts that the person will move from behind the object and towards the road and may modify the path and/or vehicle movement speed to avoid a collision.

FIG. 6E illustrates another example of the electronic device 500a outputting a user interface including a representation 630b of an impromptu path. In some embodiments, the impromptu path shown in FIG. 6E is different from the impromptu path shown in FIG. 6D because one or more of the factors listed above and/or described below with reference to method 700 are different. For example, as shown in FIG. 6E, the environment of the electronic device 500a includes object 632b at a different position from the object 632a in FIG. 6D. One or more other factors may be different between the situations in FIG. 6D and FIG. 6E. In some embodiments, the graphical user interface does not include an indication of object 632b if the object 632b is not included in the map information, but the electronic device 500a generates impromptu path 630b based in part on the location, size, and/or shape of object 632b.

In some embodiments, the graphical user interface in FIG. 6E includes a prompt 626 similar to the prompt 626 described above with respect to FIG. 6D. In some embodiments, if the electronic device 500a has relatively high confidence in the impromptu path 630b, the electronic device 500a presents the indication 630b of the impromptu path and/or an audio description 634b of the impromptu path to the user and proceeds to navigate and/or autonomously drive on the impromptu path unless the electronic device 500a receives a user input corresponding to a request to forgo navigating and/or autonomously driving on the impromptu path. For example, the electronic device 500a detects an input directed to selectable option 628 and/or a speech input corresponding to a request not to navigate and/or autonomously drive on the impromptu path. In some embodiments, in response to the input, the electronic device 500a forgoes navigating and/or autonomously driving on the impromptu path. In some embodiments, if the electronic device 500a does not receive the input after the predetermined time threshold passes since presenting the visual indication 630b of the impromptu path, the electronic device 500a proceeds to navigate and/or autonomously drive on the impromptu path.

FIG. 6F illustrates an example of the electronic device 500a outputting visual indications 630c and 630d and/or audio indication 634c of impromptu paths. In some embodiments, in accordance with the electronic device 500a having a moderate level of confidence in the generated impromptu paths, the electronic device 500a presents a plurality of path options to the user. In some embodiments, the electronic device 500a generates additional path options that are not presented to the user because the path options presented to the user have a higher multi-criteria ranking than the other generated impromptu paths. In some embodiments, the electronic device 500a presents the graphical user interface and/or an audio user interface including the indications of the path options.

For example, in FIG. 6F, the graphical user interface includes visual indications 630c and 630d of the path options, a prompt 636 requesting that the user select a path option, and selectable options 638a and 638b corresponding to the displayed path options. For example, in response to detecting selection of option 638a, the electronic device 500a proceeds to navigate and/or autonomously drive along path A corresponding to visual indication 630c. As another example, in response to detecting selection of option 638b, the electronic device 500a proceeds to navigate and/or autonomously drive along path B corresponding to visual indication 630d. In some embodiments, the electronic device 500a displays indications 630c and 630d of the paths outside of the context of imminent travel along one of the paths, such as while the electronic device 500a is not located at origin location 622 and displays the indications 630c and 630d of the paths for planning, browsing, saving, and/or sharing purposes. In some embodiments, in response to receiving an input selecting option 638a or 638b, the electronic device 500a saves and/or shares path A or path B, respectively.

Additionally or alternatively, in some embodiments, the electronic device 500a outputs audio 634c including descriptions of the impromptu paths. In some embodiments, in response to receiving a speech input 640a from the user selecting one of the impromptu paths, the electronic device 500a proceeds to navigate and/or autonomously drive on the path selected by the user. In some embodiments, if the electronic device 500a does not receive an input selecting an impromptu path, the electronic device 500a forgoes navigating and/or autonomously driving.

In some embodiments, the electronic device 500a generates and selects the impromptu paths included in FIG. 6F based on one or more of the factors and/or criteria listed above and/or described in more detail below with reference to method 700. In some embodiments, if the factors and/or criteria of the environment of the electronic device 500a were different, the electronic device 500a would generate and/or select different impromptu paths.

FIG. 6G illustrates an example of the electronic device 500a requesting user input creating an impromptu path. For example, the electronic device 500a outputs the graphical user interface shown in FIG. 6G and/or audio output 634d in situations in which the electronic device 500a has relatively low confidence in the impromptu paths generated by the electronic device 500a. As shown in FIG. 6G, the graphical user interface includes a prompt 642 directing the user to provide an input creating the impromptu path and an indication 622 of a starting location of the electronic device 500a. As shown in FIG. 6G, the electronic device 500a receives an input including movement of contact 603a drawing a path in the graphical user interface. In some embodiments, the input includes a contact similar to 603a identifying a starting location of the impromptu path and a second contact indicating an ending location of the impromptu path, rather than including movement of the contact along a desired impromptu path. In some embodiments, additionally or alternatively, the electronic device 500a receives a speech input 640b from the user describing the impromptu path. For example, the speech input includes directions about how long to proceed in a straight line, locations and/or directions of turns to make, and/or instructions to create a path towards an object in the environment of the electronic device 500a. In some embodiments, in response to receiving the input directed to the graphical user interface and/or the speech input 640b illustrated in FIG. 6G, the electronic device 500a outputs an indication of the impromptu path provided by the user, as shown in FIG. 6H.

FIG. 6H illustrates the electronic device 500a outputting a visual indication 630e and/or an audio indication 634e of the impromptu path provided by the user in FIG. 6G. In some embodiments, the electronic device 500a outputs the visual indication 630e in response to the input directed to the graphical user interface in FIG. 6G. For example, the impromptu path is the path drawn by the user with movement of contact 603g. As another example, the impromptu path is a path generated by the electronic device 101 based on a starting point and an ending point provided by the user based on one or more of the other factors described herein. In some embodiments, the electronic device 500a outputs the audio indication 634e in response to the speech input in FIG. 6G. In some embodiments, the electronic device 500a outputs the audio indication 634e in response to the input directed to the graphical user interface in FIG. 6G. In some embodiments, the electronic device 500a outputs the visual indication 630e in response to the speech input in FIG. 6G. In some embodiments, the electronic device 500a outputs both the visual indication 630e and the audio indication 634e in response to either the input directed to the graphical user interface or the speech input in FIG. 6G. In some embodiments, the electronic device 500a forgoes outputting visual indication 630e and audio indication 634e and proceeds to navigate according to the path.

FIG. 6I illustrates another example of the electronic device 500a requesting a user input providing an impromptu path, similar to the outputs of electronic device 500a described above with reference to FIG. 6G. For example, in FIG. 6I, the electronic device 500a outputs the graphical user interface including prompt 642 and an audio output 634f requesting a user input creating the impromptu path as described above with reference to FIG. 6G. As shown in FIG. 6I, the electronic device 500a receives an input directed to the graphical user interface with contact 603b and/or speech input 640c creating the impromptu path. In response to one or more of the inputs illustrated in FIG. 6I, the electronic device 500a outputs an indication of the impromptu path, as shown in FIG. 6J. In some embodiments, the electronic device 500a forgoes outputting visual indication 630f and audio indication 634g and proceeds to navigate according to the path

FIG. 6J illustrates the electronic device 500a outputting a visual indication 630f and/or an audio indication 634g of the impromptu path provided by the user in FIG. 6I. In some embodiments, the electronic device 500a outputs the visual indication 630f and/or the audio indication 634g as described above with reference to FIG. 6H.

FIG. 7 is a flow diagram illustrating a method in which an electronic device navigates or travels on predetermined paths and/or impromptu paths according to some embodiments of the disclosure. The method 700 is optionally performed at first and/or electronic devices such as device 100 or device 500 as described above with reference to FIG. 5I. Some operations in method 700 are, optionally combined and/or order of some operations is, optionally, changed.

As described below, the method 700 provides ways in which an electronic device navigates and/or travels using impromptu paths and/or predetermined paths. Efficiently navigating and/or traveling using impromptu paths and/or predetermined paths enhances the user experience by simplifying the user interaction with the electronic device, thus reducing the burden of trying to reach a destination.

In some embodiments, method 700 is performed at an electronic device (e.g., 500a) in communication with one or more input devices and one or more output devices. In some embodiments, the electronic device is a mobile device (e.g., a tablet, a media player, a smartphone, or a wearable device) including wireless communication circuitry, optionally in communication with one or more of trackpad (optionally integrated or external), a mouse (e.g., external), remote control device (e.g., external), touchpad (optionally integrated or external), a handheld device (e.g., external), another mobile device (e.g., separate from the electronic device), and/or a controller (e.g., external), etc. In some embodiments, the one or more output devices include an audio output device (e.g., one or more speakers, a headset, and/or headphones), a display component, and/or tactile output device. In some embodiments, the display component is integrated with the electronic device (e.g., a touch screen display), external to the electronic device such as a monitor, television, projector, or a hardware component (optionally integrated or external) for causing a user interface to be visible or projecting a user interface. In some embodiments, the electronic device is in communication with or integrated with a vehicle (e.g., an automobile, an aircraft, and/or a watercraft).

In some embodiments, while navigating to a physical location (702), in accordance with a determination that a current location of the electronic device (e.g., 500) at which the electronic device is navigating includes a predetermined path (e.g., 620) (included in a map being used to navigate), such as in FIG. 6B, the electronic device navigates (704) along the path while forgoing outputting, via the one or more output devices, a user interface for selecting a respective (optionally user-defined) path including the current location of the electronic device along which to navigate. In some embodiments, the predetermined path is an official road included in a map accessible to the electronic device. In some embodiments, navigating to a physical location includes presenting navigation directions to a user using the one or more output devices. For example, the electronic device instructs the user which maneuvers to make while the user is operating a vehicle. In some embodiments, navigating to a physical location includes controlling one or more actuators of a vehicle to autonomously travel along the navigation route. In some embodiments, the path is a road included in the map.

In some embodiments, while navigating to a physical location (702), in accordance with a determination that the current location of the electronic device (e.g., 500a) at which the electronic device is navigating does not include the predetermined path (e.g., 620) (included in the map being used to navigate) (706), the electronic device (e.g., 500) outputs (708), via the one or more output devices, the user interface for selecting the respective path including the current location of the electronic device along which to navigate, such as in FIG. 6F. In some embodiments, the electronic device navigates in a physical area that does not include roads or lane markings, such as remote areas for which roads are not included on the map, parking lots (e.g., that do not include parking space marking, row markings, or the like), private property, and other open areas. In some embodiments, outputting the user interface includes displaying a graphical user interface using a display component (e.g., included in the vehicle). In some embodiments, outputting the user interface includes playing audio, such as a prompt for the user to provide guidance on where to navigate. In some embodiments, as described in more detail below, the user interface includes two or more options corresponding to paths selected by the electronic device available to the vehicle for the user to select. In some embodiments, as described in more detail below, the user interface includes an interface for the user to provide a custom path for the vehicle to navigate.

In some embodiments, while navigating to a physical location (702), in accordance with a determination that the current location of the electronic device (e.g., 500a) at which the electronic device is navigating does not include the predetermined path (e.g., 620) (included in the map being used to navigate) (706), while outputting the user interface for selecting the respective path, the electronic device (e.g., 500a) receives (710), via the one or more input devices, a user input selecting the respective path, such as in FIG. 6G. In some embodiments, the user input is selection of a selected path presented by the electronic device or an input defining a custom path. In some embodiments, the user input is a voice input, an input provided using a touch screen, an input provided using a hardware button or switch, or a gesture performed by a portion (e.g., hand, arm, and/or head) of the user detected using one or more cameras.

In some embodiments, while navigating to a physical location (702), in accordance with a determination that the current location of the electronic device (e.g., 500a) at which the electronic device is navigating does not include the predetermined path (e.g., 620) (included in the map being used to navigate) (706), in response to receiving the input selecting the respective path (712), in accordance with a determination that the input corresponds to a request to select a first path, the electronic device (e.g., 500a) navigates (714) using the first path, such as in FIG. 6G. (e.g., navigating along the first path); and In some embodiments, in response to receiving the input selecting the first path, the electronic device autonomously drives along the first path. In some embodiments, in response to receiving the input selecting the first path, the electronic device presents navigation directions directing the user to drive a vehicle along the first path.

In some embodiments, while navigating to a physical location (702), in accordance with a determination that the current location of the electronic device (e.g., 500a) at which the electronic device is navigating does not include the predetermined path (e.g., 620) (included in the map being used to navigate) (706), in response to receiving the input selecting the respective path (712), in accordance with a determination that the input corresponds to a request to select a second path different from the first path, such as in FIG. 6I, the electronic device (e.g., 500a) navigates (716) using the second path (e.g., navigating along the second path). In some embodiments, in response to receiving the input selecting the second path, the electronic device autonomously drives along the second path. In some embodiments, in response to receiving the input selecting the second path, the electronic device presents navigation directions directing the user to drive a vehicle along the second path. In some embodiments, selecting the respective path is different from operating the vehicle in real time. In some embodiments, the electronic device receives the input selecting the respective path using input devices other than vehicle control input devices, such as a steering wheel, acceleration pedal, and/or brake pedal. In some embodiments, the input selecting the respective path includes input corresponding to a sequence of maneuvers to be performed along the respective path received before navigating according to the maneuvers, as opposed to receiving an input for one maneuver at a time for real-time driving. Navigating along a path included in a map when a mapped path is available and outputting a user interface for selecting a respective path when a mapped path is not available enhances user interactions with the electronic device by reducing the number of inputs needed to navigate along a predetermined path and providing improved control mechanisms to the user when a predetermined path is not available.

In some embodiments, the user interface for selecting the respective path includes, in accordance with a determination that a relationship between dimensions of a vehicle in communication with the electronic device and dimensions of an environment of the vehicle is a first relationship, an indication (e.g., 630a) of a third path corresponding to the first relationship, such as in FIG. 6D. In some embodiments, the dimensions of the vehicle include one or more of height, width, length, and/or ground clearance. In some embodiments, dimensions of the environment include dimensions of regions of the environment through which the vehicle would travel to follow a respective path. In some embodiments, the electronic device and/or vehicle senses the dimensions of the environment using one or more sensors, such as lidar, range sensors, radar, and/or cameras. In some embodiments, the electronic device obtains information about the dimensions of the environment from mapping information corresponding to the current location of the electronic device and/or vehicle. For example, the electronic device senses the vertical height between the ground and an object under which the vehicle would drive, such as a bridge, overpass, archway, or overhanging roof. As another example, the electronic device senses the width of a pathway between two or more of wall(s), building(s), railing(s), and/or other vehicle(s). As another example, the electronic device senses the height of an object the vehicle would drive over, such as a speed bump, ditch, and/or hill. As another example, the electronic device senses the turn radius of a turn included in a respective path. In some embodiments, the third path is a path through which the vehicle will physically fit. In some embodiments, the electronic device receives an input selecting the third path and, in response navigates using the third path as described in more detail above. In some embodiments, in accordance with the determination that the relationship between the dimensions of the vehicle and the environment is the first relationship, the electronic device forgoes displaying the indication of the fourth path described below.

In some embodiments, the user interface for selecting the respective path includes, in accordance with a determination that the relationship between the dimensions of the vehicle and the dimensions of the environment of the vehicle is a second relationship different from the first relationship, an indication (e.g., 630b) of a fourth path corresponding to the second relationship, the fourth path different from the third path, such as in FIG. 6E. In some embodiments, the fourth path is a path through which the vehicle will physically fit. In some embodiments, the electronic device forgoes presenting an indication of a path through which the vehicle will not fit. In some embodiments, the user interface further includes one or more indications of additional path options through which the vehicle will fit. In some embodiments, the indication of the third path and the indication of the fourth path are visual and/or audio indications. In some embodiments, the electronic device receives an input selecting the fourth path and, in response navigates using the fourth path as described in more detail above. In some embodiments, in accordance with the determination that the relationship between the dimensions of the vehicle and the environment is the second relationship, the electronic device forgoes displaying the indication of the third path described above. Presenting the indication of a path selected based on the dimensions of the vehicle and dimensions of the environment of the vehicle enhances user interactions with the electronic device by efficiently providing a path likely to be desired by the user based on the dimensions of the vehicle and environment.

In some embodiments, the user interface for selecting the respective path includes, in accordance with a determination that weather conditions at the current location of the electronic device are first weather conditions, a third path (e.g., 630a) corresponding to the first weather conditions, such as in FIG. 6D. In some embodiments, the weather conditions include temperature, precipitation, sun and/or cloud conditions, and/or humidity at the current location of the electronic device. For example, on a hot and sunny day, the electronic device presents a path with more shade than the path that would be presented on an overcast and/or cool day. As another example, on a cold day, the electronic device presents a path with less shade than a path that would be presented on a hot and/or sunny day. As another example, if there is snow in the current location of the electronic device, the electronic device presents a path that is already plowed. In some embodiments, the electronic device receives an input selecting the third path and, in response navigates using the third path as described in more detail above. In some embodiments, in accordance with the determination that the weather conditions are the first weather conditions, the electronic device forgoes displaying the indication of the fourth path described below.

In some embodiments, the user interface for selecting the respective path includes, in accordance with a determination that the weather conditions at the current location of the electronic device are second weather conditions different from the first weather conditions, a fourth path (e.g., 630b) corresponding to the second weather conditions, the fourth path different from the first path, such as in FIG. 6E. In some embodiments, the electronic device presents a different path depending on different weather conditions at the current location of the electronic device. In some embodiments, the electronic device receives an input selecting the fourth path and, in response navigates using the fourth path as described in more detail above. In some embodiments, in accordance with the determination that the weather conditions are the second weather conditions, the electronic device forgoes displaying the indication of the third path described above. Presenting the indication of the path selected based on weather conditions at the current location of the electronic device enhances user interactions with the electronic device by efficiently providing a path likely to be desired by the user based on current weather conditions.

In some embodiments, such as in FIG. 6G, the user interface for selecting the respective path includes a prompt (e.g., 642) for the user to create the respective path. In some embodiments, the electronic device presents audio requesting user input creating the respective path. In some embodiments, the electronic device displays a visual indication requesting user input creating the respective path. In some embodiments, the user interface does not include a portion of the respective path and the request for user input is a request for user input creating a path starting at the location of the electronic device without defining an end point.

In some embodiments, such as in FIG. 6G, the user input includes input (e.g., via contact 603a) corresponding to creation of the respective path. In some embodiments, the user input is a voice and/or speech input that includes spoken directions corresponding to the respective path, as described in more detail below. In some embodiments, the user input is an input to “draw” the path on a representation of the environment of the electronic device included in a displayed user interface. For example, while displaying the user interface on a touch screen, the electronic device receives an input including movement of a proximate object (e.g., a user's finger or a stylus) drawing the respective path (e.g., from the current location of the vehicle and/or electronic device to a proposed final location of the vehicle and/or electronic device). Presenting a user interface for the user to use to create the respective path enhances user interactions with the electronic device by providing an efficient way for the user to control the path used to navigate (e.g., or drive) to the destination.

In some embodiments, such as in FIG. 6G, the user input selecting the respective path includes a voice input (640b). In some embodiments, the voice input selects one of a plurality of path options presented by the electronic device. In some embodiments, the voice input confirms use of a respective path presented by the electronic device. In some embodiments, the voice input creates the respective path by providing verbal directions to the electronic device (e.g., without the electronic device presenting a proposed path). For example, the voice input includes distances to travel straight, landmarks to be traveled to before turning and/or stopping, turns, and/or stops to be made to follow the respective path. Accepting voice input to select the respective path enhances user interactions with the electronic device by providing a hands-free and/or eyes-free interface for providing user feedback, thereby improving user safety while using the electronic device while in a vehicle.

In some embodiments, the user interface for selecting the respective path includes, in accordance with a determination that a vehicle in communication with the electronic device previously followed a third path including a current location of the vehicle, an indication (e.g., 630a) of a fourth path based on the third path, such as in FIG. 6D. In some embodiments, the fourth path is the same as the third path. In some embodiments, a portion of the fourth path includes a portion of the third path. In some embodiments, the fourth path is additionally based on one or more other factors, such as those described above and/or below. For example, if one or more of the other factors and/or conditions described herein are different from factors and/or conditions when the third path was taken, the electronic device modifies one or more portions of the third path in accordance with the current factors and/or conditions. In some embodiments, the third path was traveled by the user of the electronic device. In some embodiments, the third path was traveled by a different user than the user of the electronic device. In some embodiments, the third path was traveled by an electronic device different from the electronic device. In some embodiments, the electronic device receives an input selecting the fourth path and, in response navigates using the fourth path as described in more detail above. In some embodiments, in accordance with the determination that the vehicle previously followed the third path, the electronic device forgoes displaying the indication of the sixth path described below.

In some embodiments, the user interface for selecting the respective path includes, in accordance with a determination that the vehicle previously followed a fifth path including the current location of the vehicle, the fifth path different from the third path, an indication (e.g., 630b) of a sixth path based on the fifth path, the sixth path different from the fourth path, such as in FIG. 6E. In some embodiments, the fifth path is the same as the sixth path. In some embodiments, a portion of the sixth path includes a portion of the fifth path. In some embodiments, the sixth path is additionally based on one or more other factors, such as those described above and/or below. For example, if one or more of the other factors and/or conditions described herein are different from factors and/or conditions when the fifth path was taken, the electronic device modifies one or more portions of the fifth path in accordance with the current factors and/or conditions. In some embodiments, the fifth path was traveled by the user of the electronic device. In some embodiments, the fifth path was traveled by a different user than the user of the electronic device. In some embodiments, the fifth path was traveled by an electronic device different from the electronic device. In some embodiments, the electronic device receives an input selecting the sixth path and, in response navigates using the sixth path as described in more detail above. In some embodiments, in accordance with the determination that the vehicle previously followed the fifth path, the electronic device forgoes displaying the indication of the fourth path described above. Presenting a path based on a path previously traveled by the vehicle enhances user interactions with the electronic device by reducing the number of inputs needed to produce a path similar to the previously-used path.

In some embodiments, in accordance with a determination that a user of the electronic device previously followed a third path including a current location of the electronic device, the user interface for selecting the respective path includes an (e.g., 630a) indication of a fourth path based on the third path, such as in FIG. 6D. In some embodiments, the fourth path is the same as the third path. In some embodiments, a portion of the fourth path includes a portion of the third path. In some embodiments, the fourth path is additionally based on one or more other factors, such as those described above and/or below. For example, if one or more of the other factors and/or conditions described herein are different from factors and/or conditions when the third path was taken, the electronic device modifies one or more portions of the third path in accordance with the current factors and/or conditions. In some embodiments, the third path was traveled using the same vehicle as the vehicle in communication with the electronic device. In some embodiments, the third path was traveled using a different vehicle than the vehicle in communication with the electronic device. In some embodiments, the third path was traveled by the same electronic device. In some embodiments, the third path was traveled using a different electronic device. In some embodiments, the electronic device receives an input selecting the fourth path and, in response navigates using the fourth path as described in more detail above. In some embodiments, in accordance with the determination that the user previously followed the third path, the electronic device forgoes displaying the indication of the sixth path described below.

In some embodiments, in accordance with a determination that the user previously followed a fifth path including the current location of the electronic device, the fifth path different from the third path, the user interface for selecting the respective path includes an indication (e.g., 630b) of a sixth path based on the fifth path, the sixth path different from the fourth path, such as in FIG. 6E. In some embodiments, the fifth path is the same as the sixth path. In some embodiments, a portion of the sixth path includes a portion of the fifth path. In some embodiments, the sixth path is additionally based on one or more other factors, such as those described above and/or below. For example, if one or more of the other factors and/or conditions described herein are different from factors and/or conditions when the fifth path was taken, the electronic device modifies one or more portions of the fifth path in accordance with the current factors and/or conditions. In some embodiments, the fifth path was traveled using the same vehicle as the vehicle that is in communication with the electronic device. In some embodiments, the fifth path was traveled using a different vehicle from the vehicle that is in communication with the electronic device. In some embodiments, the fifth path was traveled by the same electronic device. In some embodiments, the fifth path was traveled using a different electronic device. In some embodiments, the electronic device receives an input selecting the sixth path and, in response navigates using the sixth path as described in more detail above. In some embodiments, in accordance with the determination that the user previously followed the fifth path, the electronic device forgoes displaying the indication of the fourth path described above. Presenting a path based on a path previously traveled by the user enhances user interactions with the electronic device by reducing the number of inputs needed to produce a path similar to the previously-used path.

In some embodiments, in accordance with a determination that a second electronic device previously followed a third path including a current location of the electronic device, the user interface for selecting the respective path includes an indication of a fourth path (e.g., 630a) based on the third path, such as in FIG. 6D. In some embodiments, the fourth path is the same as the third path. In some embodiments, a portion of the fourth path includes a portion of the third path. In some embodiments, the fourth path is additionally based on one or more other factors, such as those described above and/or below. For example, if one or more of the other factors and/or conditions described herein are different from factors and/or conditions when the third path was taken, the electronic device modifies one or more portions of the third path in accordance with the current factors and/or conditions. In some embodiments, the third path was traveled by the user of the electronic device. In some embodiments, the third path was traveled by a different user from the user of the electronic device. In some embodiments, the third path was traveled by a plurality of users, electronic devices, and/or vehicles. In some embodiments, the electronic device receives an input selecting the fourth path and, in response navigates using the fourth path as described in more detail above. In some embodiments, in accordance with the determination that the second electronic device previously followed the third path, the electronic device forgoes displaying the indication of the sixth path described below.

In some embodiments, in accordance with a determination that the second electronic device previously followed a fifth path including the current location of the electronic device, the fifth path different from the third path, the user interface for selecting the respective path includes an indication (e.g., 630b) of a sixth path based on the fifth path, the sixth path different from the fourth path, such as in FIG. 6E. In some embodiments, the fifth path is the same as the sixth path. In some embodiments, a portion of the sixth path includes a portion of the fifth path. In some embodiments, the sixth path is additionally based on one or more other factors, such as those described above and/or below. For example, if one or more of the other factors and/or conditions described herein are different from factors and/or conditions when the fifth path was taken, the electronic device modifies one or more portions of the fifth path in accordance with the current factors and/or conditions. In some embodiments, the fifth path was traveled by the user of the electronic device. In some embodiments, the fifth path was traveled by a different user from the user of the electronic device. In some embodiments, the fifth path was traveled by a plurality of users, electronic devices, and/or vehicles. In some embodiments, the electronic device receives an input selecting the sixth path and, in response navigates using the sixth path as described in more detail above. In some embodiments, in accordance with the determination that the second electronic device previously followed the fifth path, the electronic device forgoes displaying the indication of the fifth path described above. Presenting a path based on a path previously traveled by a second electronic device enhances user interactions with the electronic device by reducing the number of inputs needed to produce a path similar to the previously-used path.

In some embodiments, the electronic device (e.g., 500a) receives, from a second electronic device (e.g., 500b) associated with the current location of the electronic device, path information for the current location of the electronic device, such as in FIG. 6A.

In some embodiments, while navigating to the physical location, in accordance with the determination that that current location of the electronic device (e.g., 500a) at which the electronic device is navigating does not include the predetermined path (e.g., 620 in FIG. 6B), in accordance with a determination that the path information from the second electronic device includes first path information, the user interface for selecting the respective path includes an indication (e.g., 630a) of a third path based on the first path information, such as in FIG. 6D. In some embodiments, the second electronic device is operated by an owner and/or manager of the property located at the current location of the electronic device. For example, a manager of a shopping center configures the second electronic device to provide a respective path for navigating the parking lot of the shopping center. In some embodiments, in accordance with the determination that the path information from the second electronic device includes the first path information, the electronic device forgoes presenting the indication of the fourth path described below. In some embodiments, the electronic device receives an input selecting the indication of the third path and, in response to receiving the input, navigates using the third path.

In some embodiments, while navigating to the physical location, in accordance with the determination that that current location of the electronic device (e.g., 500a) at which the electronic device is navigating does not include the predetermined path (e.g., 620 in FIG. 6B), in accordance with a determination that the path information from the second electronic device includes second path information different from the first path information, the user interface for selecting the respective path includes an indication (e.g., 630b) of a fourth path based on the second path information, the fourth path different from the third path, such as in FIG. 6E. In some embodiments, the path information provided by the second electronic device is not included in a map accessed by the electronic device that includes the predetermined path. In some embodiments, the path information includes one or more paths for navigating the environment of the electronic device provided by the owner and/or manager of the property located at the current location of the electronic device. In some embodiments, the path information includes one or more regions of the environment that should not be included in a path for navigating the location. In some embodiments, in accordance with the determination that the path information from the second electronic device includes the second path information, the electronic device forgoes presenting the indication of the third path described above. In some embodiments, the electronic device receives an input selecting the indication of the fourth path and, in response to receiving the input, navigates using the fourth path. Presenting the indication of a path based on path information provided by the second electronic device associated with the current location of the electronic device enhances interactions with the electronic device by efficiently providing a path preferred by a person of authority in the current location, thereby improving safety and/or efficiency while navigating the location.

In some embodiments, while navigating to the physical location, the electronic device (e.g., 500a) detects, via the one or more input devices (e.g., sensors 602 in FIG. 6A), an object in an environment of the electronic device that is not included in map information accessible to the electronic device. In some embodiments, the object is an object that should be avoided by a vehicle in communication with the electronic device and the location of the object should not be included in the respective path. In some embodiments, the predetermined path is included in the map information. In some embodiments, a plurality of other electronic devices have access to the map information.

In some embodiments, while navigating to the physical location, in accordance with a determination that the object satisfies one or more criteria, the electronic device (e.g., 500a) updates the map information to include information associated with the object. In some embodiments, satisfying the one or more criteria corresponds to the object being a long-term feature of the location, such as a building, wall, fence, curb, traffic sign (e.g., stop sign, do not enter sign, or one way sign) that is more likely to remain in its location than it is to be removed from its location. For example, the electronic device uses machine learning, scene understanding, and/or computer vision techniques to categorize the object and determine whether or not the category of object satisfies the one or more criteria. In some embodiments, the electronic device stores the size and location of the object in the map information and uses the information associated with the object to plan paths in the current location in the future. In some embodiments, the electronic device shares the size and location of the object with one or more other electronic devices that have access to the map information, which optionally enables the one or more other electronic devices to use the size and location of the object when navigating using the map information. For example, if the electronic device had planned a path that would intersect the object and has to formulate a new path to avoid the object, the next time the electronic device navigates in that location, the electronic device formulates a different path to avoid the object, optionally in a more efficient manner.

In some embodiments, while navigating to the physical location, in accordance with a determination that the object does not satisfy the one or more criteria, the electronic device (e.g., 500a) forgoes updating the map information to include the information associated with the object. In some embodiments, not satisfying the one or more criteria corresponds to the object being a short-term feature of the location, such as a human, animal, vehicle, temporary traffic object (e.g., traffic cone, sawhorse, or law enforcement closure of a roadway) that is more likely to be moved from its location than it is to remain in its location. In some embodiments, the electronic device avoids the object (or more generally accounts for the object for path planning purposes) but does not store the size and/or location of the object as map information. Selectively updating the mapping information to includes objects that satisfy one or more criteria without updating the mapping information to include objects that do not satisfy the one or more criteria enhances user interactions with the electronic device by formulating paths based on updated information, thereby providing more efficient navigation paths.

In some embodiments, while navigating to the physical location, at a first time, the electronic device (e.g., 500a) detects, via the one or more input devices (e.g., sensors 602 in FIG. 6A), an object in an environment of the electronic device that is not included in map information accessible to the electronic device. In some embodiments, the object is a human or an animal. In some embodiments, the electronic device identifies the object using machine learning, computer vision, and/or scene understanding techniques. In some embodiments, the object is moving. In some embodiments, the predetermined path is included in the map information.

In some embodiments, while navigating to the physical location, at a second time different form the first time, the electronic device (e.g., 500) detects, via the one or more input devices (e.g., sensors 602 in FIG. 6A), the object; and In some embodiments, between the first time and the second time, the electronic device does not detect the object. For example, the object moves behind another object that occludes the object from the field of view of one or more sensors (e.g., cameras) of the electronic device.

In some embodiments, while navigating to the physical location, the electronic device (e.g., 500a) tracks the object in the environment of the electronic device based on detecting the object at the first time and at the second time. In some embodiments, tracking movement of the object includes predicting future movement of the object. For example, the electronic device senses the object moving towards an upcoming portion of a path of the electronic device followed by the object being occluded by another object. In this example, the electronic device predicts the object to emerge from behind the other object and continue towards the upcoming portion of the path and slows down, stops, or modifies the path to avoid a collision with the object. Tracking the object enhances user interactions with the electronic device by enabling the electronic device to modify the path to avoid collision with the object, enhancing safety of operation of the electronic device.

In some embodiments, the user interface for selecting the respective path includes representations (e.g., 630a) of one or more path options, such as in FIG. 6D. In some embodiments, the user interface is a graphical user interface that includes a representation of the environment of the electronic device and visual indications of the one or more paths. For example, the user interface includes a map from a bird's eye view that includes the indication(s) of the path(s). In some embodiments, the user interface is an audio-based user interface that includes an audio description of the one or more path options.

In some embodiments, in accordance with a determination that one or more first path options (e.g., 630a) satisfy a set of criteria and one or more second path options different from the one or more first path options do not satisfy the set of criteria, the user interface for selecting the respective path includes representations (e.g., 630a) of the one or more first path options, such as in FIG. 6D. In some embodiments, the electronic device generates the one or more first path options and the one or more second path options and ranks the path options according to the set of criteria and presents a subset of the path options that have the highest ranking using the one or more criteria. In some embodiments, the criteria include the criteria and/or factors described above and below. In some embodiments, the electronic device weighs the criteria when evaluating the path options, assigning more weight to some criteria and less weight to other criteria. In some embodiments, in accordance with the determination that the one or more first path options satisfy the set of criteria and the one or more second path options do not satisfy the set of criteria, the user interface excludes the one or more second path options. In some embodiments, in accordance with the determination that the one or more first path options satisfy the set of criteria and the one or more second path options do not satisfy the set of criteria, the electronic device forgoes presenting the one or more second path options described below. In some embodiments, the electronic device receives an input selecting one of the first path options and, in response to receiving the input, navigates using a respective path corresponding to the selected first path option.

In some embodiments, in accordance with a determination that the one or more second path options (e.g., 630b) satisfy the set of criteria and the one or more first path options do not satisfy the set of criteria, the user interface for selecting the respective path includes representations (e.g., 630b) of the one or more second path options, such as in FIG. 6E. In some embodiments, in accordance with the determination that the one or more second path options satisfy the set of criteria and the one or more first path options do not satisfy the set of criteria, the user interface excludes the one or more first path options. In some embodiments, in accordance with the determination that the one or more second path options satisfy the set of criteria and the one or more first path options do not satisfy the set of criteria, the electronic device forgoes presenting the one or more first path options described above. In some embodiments, the electronic device receives an input selecting one of the second path options and, in response to receiving the input, navigates using a respective path corresponding to the selected second path option. Selecting the path options to include in the user interface according to the set of criteria enhances user interactions with the electronic device by reducing the number of inputs and battery life needed to select a suitable path.

In some embodiments, the user interface for selecting the respective path includes representations (e.g., 630c and/or 630d) of one or more path options, such as in FIG. 6F. In some embodiments, the path options are presented as described above.

In some embodiments, in accordance with a determination that vehicles in an environment of the electronic device have a first behavior, the user interface for selecting the respective path includes representations (e.g., 630a) of one or more first path options, such as in FIG. 6D. In some embodiments, vehicle behavior includes speed, direction of travel, merging behavior, and/or location of the vehicles in the environment of the electronic device. In some embodiments, the one or more first path options include path options that avoid other vehicles, follow other vehicles, or yield to other vehicles depending on the situation. In some embodiments, in accordance with the determination that the vehicles in the environment have the first behavior, the electronic device forgoes presenting the one or more second path options described below. In some embodiments, the electronic device receives an input selecting one of the first path options and, in response to receiving the input, navigates using a respective path corresponding to the selected first path option.

In some embodiments, in accordance with a determination that the vehicles in the environment of the electronic device have a second behavior different from the first behavior, the user interface for selecting the respective path includes representations (e.g., 630b) of one or more second path options different from the one or more first path options, such as in FIG. 6D. In some embodiments, the one or more second path options are different from the one or more first path options because the one or more second path options avoid other vehicles, whereas the one or more first path options follow other vehicles or yield to other vehicles. In some embodiments, the one or more second path options are different from the one or more first path options because the one or more second path options follow other vehicles, whereas the first path options avoid other vehicles or yield to other vehicles. In some embodiments, the one or more second path options are different from the one or more first path options because the one or more second path options yield to other vehicles, whereas the one or more first path options avoid other vehicles or follow other vehicles. In some embodiments, the one or more first path options and the one or more second path options avoid other vehicles, follow other vehicles, or yield to other vehicles but do so in different ways due to differences in the behavior of the other vehicles. In some embodiments, in accordance with the determination that the vehicles in the environment have the second behavior, the electronic device forgoes presenting the one or more first path options described above. In some embodiments, the electronic device receives an input selecting one of the second path options and, in response to receiving the input, navigates using a respective path corresponding to the selected second path option. Presenting path options based on the behavior of other vehicles in the environment of the electronic device enhances user interactions with the electronic device by enhancing safety and efficiency of the paths presented by the electronic device.

In some embodiments, while navigating to the physical location and while the current location of the electronic device does not include the predetermined path, the electronic device (e.g., 500a) detects, using the one or more input devices (e.g., sensors 602 in FIG. 6A), a human in an environment of the electronic device providing path directions. In some embodiments, the electronic device detects the human providing the path directions using gestures (e.g., waving hands and/or holding a traffic sign) and/or verbal instructions. In some embodiments, the directions include one or more of directions to stop, go, turn, merge, drive to a lane or location, and/or follow another vehicle or object. In some embodiments, the human is external to the vehicle the user is using to navigate the paths. In some embodiments, the human is different from the user of the electronic device.

In some embodiments, such as in FIG. 6D, the user interface for selecting the respective path includes representations (e.g., 630a) of one or more path options. In some embodiments, the electronic device presents the path options as described in more detail above.

In some embodiments, in accordance with a determination that the path directions provided by the human include first path directions, the user interface for selecting the respective path includes representations (e.g., 630a) of one or more first path options corresponding to the first path directions, such as in FIG. 6D. In some embodiments, the one or more first path options follow the first path directions provided by the human. In some embodiments, in accordance with the determination that the path directions provided by the human include the first path directions, the electronic device forgoes presenting the one or more second path options described below. In some embodiments, the electronic device receives an input selecting one of the first path options and, in response to receiving the input, navigates using a respective path corresponding to the selected first path option.

In some embodiments, in accordance with a determination that the path directions provided by the human include second path directions different from the first path directions, the user interface for selecting the respective path includes representations (e.g., 630b) of one or more second path options different from the first path options corresponding to the second path directions, such as in FIG. 6E. In some embodiments, the one or more second path options follow the second path directions provided by the human. In some embodiments, the path options are included in paths to the destination. In some embodiments, in accordance with a determination that that path directions provided by the human are not compatible with reaching the destination, the path options include an option to leave the area and use an alternative path to reach the destination. In some embodiments, in accordance with the determination that the path directions provided by the human include the second path directions, the electronic device forgoes presenting the one or more first path options described above. In some embodiments, the electronic device receives an input selecting one of the second path options and, in response to receiving the input, navigates using a respective path corresponding to the selected second path option. Presenting path options in accordance with directions provided by a person in the environment of the electronic device enhances user interactions with the electronic device by efficiently and automatically incorporating the directions into navigation to a destination.

In some embodiments, while navigating to the physical location and while the current location of the electronic device does not include the predetermined path, in accordance with a determination that the path directions provided by the human fail to meet one or more criteria, the electronic device (e.g., 500a) outputs the user interface for selecting the respective path including a request (e.g., 636 and/or 634c) for user input to select the respective path, such as in FIG. 6F. In some embodiments, the one or more criteria are associated with confidence in the electronic device's interpretation of the path directions provided by the human. In some embodiments, failing to meet the one or more criteria corresponds to the confidence in the electronic device's interpretation of the path directions provided by the human being less than a predetermined threshold level. In some embodiments, the electronic device compares the confidence to a plurality of predefined threshold levels and presents different user interfaces for selecting the respective path based on the thresholds met or not met by the confidence, as described in more detail below. For example, the more confident the electronic device is in its interpretation of the path directions provided by the human, the less intervention will be requested of the user. In some embodiments, in accordance with a determination that the directions provided by the human satisfy the one or more criteria, the electronic device selects the respective path without user input. In some embodiments, the electronic device additionally presents an indication of the respective path. Requesting user input to select the respective path in accordance with the determination that the path directions provided by the human fail to meet the one or more criteria enhances user interactions by improving safety and reducing errors when the electronic device confidence in the human-provided directions is low and improving efficiency when the electronic device confidence in the human-provided directions is high.

In some embodiments, in accordance with the determination that the path directions provided by the human fail to meet the one or more criteria (and the confidence the electronic device has in its interpretation of the directions is relatively high compared to the degrees of confidence described below), presenting the user interface for selecting the respective path including the request for user input to select the respective path includes presenting, using the one or more output devices, an indication (e.g., 630b) of the respective path and an option (e.g., 628) that, when selected, causes the electronic device to forgo navigating along the respective path, such as in FIG. 6E. In some embodiments, the electronic device presents the representation of the respective path as described in more detail above. In some embodiments, the option is an option the electronic device displays in a graphical user interface and detecting selection of the option includes detecting an input directed to the displayed option. In some embodiments, the option is an audio prompt and detecting selection of the option includes detecting a speech input corresponding to a request to forgo navigating along the path.

In some embodiments, in accordance with the determination that the path directions provided by the human fail to meet the one or more criteria (and the confidence the electronic device has in its interpretation of the directions is relatively high compared to the degrees of confidence described below), while navigating to the physical location, in accordance with a determination that the user interface for selecting the respective path, such as in FIG. 6E, has been presented for greater than a predetermined time threshold (e.g., without detecting selection of the selectable option), the electronic device (e.g., 500) navigates along the respective path. In some embodiments, the predetermined time threshold is 1, 2, 3, 5, 10, 15, or 30 seconds. In some embodiments, in response to detecting selection of the selectable option, the electronic device forgoes navigating along the respective path. Additionally or alternatively, in some embodiments, the electronic device presents one or more alternative path options in the user interface. In some embodiments, the electronic device presents the indication of the respective path and the option in accordance with the confidence in the respective path being relatively high compared to the other confidence thresholds. Concurrently presenting the indication of the respective path and the option to forgo navigating the respective path and navigating along the respective path after the time threshold enhances user interactions with the electronic device by allowing the user to prevent the electronic device from navigating the path, thereby improving safety, or automatically navigating the path if the user does not prevent the electronic device from navigating the respective path, thereby improving efficiency.

In some embodiments, in accordance with the determination that the path directions provided by the human fail to meet the one or more criteria (and the confidence the electronic device has in its interpretation of the directions is moderate compared to the degrees of confidence described above and below), the electronic device (e.g., 500a) presents the user interface for selecting the respective path including the request for user input to select the respective path includes presenting a plurality of path options (e.g., 630c and/or 630d) based on the path directions provided by the human, such as in FIG. 6F. In some embodiments, the electronic device presents the plurality of path options based on the path directions provided by the human in response to the confidence of the plurality of path options being moderate compared to the other confidence thresholds. In some embodiments, unless and until the electronic device receives a user input selecting one of the path options, the electronic device forgoes navigating according to the respective path option. In some embodiments, the electronic device presents the plurality of path options as described in more detail above. Presenting multiple path options based on the path directions provided by the human enhances user interactions with the electronic device by improving safety and reducing the time and inputs needed to follow a path in accordance with the path directions provided by the human.

In some embodiments, in accordance with the determination that the path directions provided by the human fail to meet the one or more criteria (and the confidence the electronic device has in its interpretation of the directions is relatively low compared to the degrees of confidence described above), the electronic device (e.g., 500a) presents the user interface for selecting the respective path including the request for user input to select the respective path includes presenting a prompt (e.g., 642 and/or 634d) for the user to provide the respective path. In some embodiments, the electronic device presents the prompt for the user to provide the respective path in accordance with the electronic device's confidence in the path directions provided by the human being low compared to other confidence thresholds. In some embodiments, the electronic device forgoes navigating along the respective path unless and until the electronic device receives the user input providing the respective path. In some embodiments, the user input is directed to a graphical user interface, such as the user drawing the respective path on a representation of the environment of the electronic device. In some embodiments, the user input is a speech input, such as verbal instructions for following the path. In some embodiments, in response to receiving the user input, the electronic device navigates along the respective path. In some embodiments, the electronic device forgoes navigating along the respective path unless and until the electronic device receives the user input. Requesting that the user provide the respective path in accordance with the path directions provided by the human failing to meet the one or more criteria enhances user interactions with the electronic device by improving safety through additional user oversight.

In some embodiments, while navigating to the physical location, in accordance with the determination that the current location of the electronic device does not include the predetermined path, in accordance with a determination that a vehicle in an environment of the electronic device is traveling along a path that satisfies one or more criteria (e.g., based on data 614 from one or more sensors 602 or communication with a second device 500b associated with the vehicle, such as in FIG. 6A), the electronic device (e.g., 500a) navigates) along the path along which the vehicle is traveling (e.g., without outputting the user interface for selecting the respective path). In some embodiments, the path of the vehicle satisfies the one or more criteria when it is included in a path to the destination. In some embodiments, navigating along the path along which the vehicle is traveling includes following the vehicle. In some embodiments, the electronic device continues to navigate along the path along which the vehicle is traveling (e.g., follow the vehicle) while the path continues to satisfy the one or more criteria. In some embodiments, the electronic device forgoes outputting the user interface. In some embodiments, the electronic device outputs the user interface including an indication of the path of the vehicle.

In some embodiments, while navigating to the physical location, in accordance with the determination that the current location of the electronic device does not include the predetermined path, in accordance with a determination that the vehicle in an environment of the electronic device is traveling along a path that fails to satisfy the one or more criteria (e.g., based on data 614 from one or more sensors 602 or communication with a second device 500b associated with the vehicle, such as in FIG. 6A), outputting the user interface for selecting the respective path, such as in FIGS. 6D-6J. In some embodiments, while navigating along the path along which the vehicle is traveling (e.g., following the vehicle), in accordance with a determination that the path no longer satisfies the one or more criteria, the electronic device ceases following the vehicle and presents the user interface for selecting the respective path. In some embodiments, the user interface for selecting the respective path includes one or more path options different from the path of the vehicle. Navigating along the path along which the vehicle is traveling in accordance with the path satisfying the one or more criteria enhances user interactions with the electronic device by efficiently and safely navigating to the destination without disrupting other vehicles in the environment of the electronic device.

In some embodiments, while navigating to the physical location, in accordance with the determination that the current location of the electronic device does not include the predetermined path, in accordance with a determination that an environment of the electronic device includes one or more objects indicating a path (e.g., sensed by sensors 602 in FIG. 6A), the electronic device (e.g., 500a) navigates along the path indicated by the one or more objects (e.g., without outputting the user interface for selecting the respective path). In some embodiments, the one or more objects are not included in the mapping information. In some embodiments, the objects are temporary traffic objects, such as cones, sawhorses, temporary traffic signs, and/or law enforcement directing traffic. In some embodiments, the electronic device uses machine learning, scene understanding, computer vision, and/or one or more algorithms to determine the path indicated by the one or more objects. In some embodiments, the electronic device detects the one or more objects using one or more sensors. In some embodiments, in accordance with the determination that the environment of the electronic device includes the one or more objects indicating a path, the electronic device outputs the user interface with an indication of the path indicated by the one or more objects. In some embodiments, in accordance with the determination that the environment of the electronic device includes the one or more objects indicating a path, the electronic device forgoes outputting the user interface. In some embodiments, the electronic device navigates along the path indicated by the one or more objects in accordance with a determination that the path indicated by the one or more objects is included in a path to the destination. In accordance with a determination that the path indicated by the one or more objects is not included in the path to the destination, the electronic device forgoes navigating along the path indicated by the one or more objects and presents the user interface for selecting the respective path.

In some embodiments, while navigating to the physical location, in accordance with the determination that the current location of the electronic device does not include the predetermined path, in accordance with a determination that the environment of the electronic device does not include the one or more objects indicating the path (e.g., based on data 614 sensed by sensors 602), the electronic device (e.g., 500a) outputs the user interface for selecting the respective path, such as in FIGS. 6D-6J. In some embodiments, the user interface for selecting the respective path includes one or more indications of one or more paths different from the path indicated by the one or more objects. Navigating along the path indicated by the one or more objects in accordance with a determination that the environment includes the one or more objects and outputting the user interface for selecting the respective path in accordance with a determination that the environment does not include the one or more objects enhances user interactions with the electronic device by efficiently navigating along the path when the one or more objects indicate the path, thereby reducing inputs and conserving battery life, and improving safety when the one or more objects do not indicate the path.

In some embodiments, outputting the user interface for selecting the respective path includes displaying, via a display component included in the one or more output devices, a visual indication (e.g., 630a) of the respective path, such as in FIG. 6D. In some embodiments, the visual indication of the respective path is displayed in a user interface that includes a representation of the environment of the electronic device, such as a map. In some embodiments, the electronic device generates the representation based on map information and/or data collected by one or more sensors in communication of the electronic device. Displaying the visual indication of the respective path enhances user interactions with the electronic device by providing improved visual feedback to the user.

In some embodiments, the user interface for selecting the respective path includes representations (e.g., 630c and/or 630d) of one or more path options, such as in FIG. 6F. In some embodiments, the electronic device outputs the one or more path options as described in more detail above.

In some embodiments, in accordance with a determination that an environment of the electronic device is a first type of environment, the one or more path options (e.g., 630a) are selected according to a first set of one or more criteria, such as in FIG. 6D. In some embodiments, the electronic device uses machine learning, scene understanding, and/or computer vision technique(s) to determine the type of the environment. Example types of environments include parking lots, drive-through windows, curbside pickup, event parking, and/or private property. In some embodiments, the electronic device receives an input selecting one of the path options and, in response navigates using the path corresponding to the selected path option as described in more detail above. In some embodiments, in accordance with the determination that the environment is the first type, the electronic device forgoes displaying the one or more path options selected according to the second set of one or more criteria described in more detail below.

In some embodiments, in accordance with a determination that the environment of the electronic device is a second type of environment different from the first type of environment, the one or more path options (e.g., 630b) are selected according to a second set of one or more criteria different from the first set of one or more criteria, such as in FIG. 6E. In some embodiments, in accordance with the determination that the environment of the electronic device is the first type of environment, the user interface includes representations of one or more first paths selected and/or generated based on the first set of one or more criteria. In some embodiments, in accordance with the determination that the environment of the electronic device is the second type of environment, the user interface includes representations of one or more second paths different from the first paths selected and/or generated based on the second set of one or more criteria. In some embodiments, the electronic device prioritizes different characteristics when selecting the path option(s) to output depending on the type of the environment. In some embodiments, the prioritization of the characteristics is based on differences in appropriate driving behavior in different situations. For example, following other vehicles may have a high priority for a drive-through window of a restaurant but not for a parking lot. In some embodiments, the electronic device receives an input selecting one of the path options and, in response navigates using the path corresponding to the selected path option as described in more detail above. In some embodiments, in accordance with the determination that the environment is the second type, the electronic device forgoes displaying the one or more path options selected according to the first set of one or more criteria described in more detail above. Selecting path options with different criteria depending on the type of environment the electronic device is in enhances user interactions with the electronic device by improving safety and efficiency.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein.

The operations in the methods described above are, optionally, include running one or more functional modules in an apparatus such as general purpose processors (e.g., a as described with FIG. 5I) and/or application-specific circuitry. Further, the operations described above with reference to FIG. 7 are, optionally, implemented by components depicted in FIG. 5I. When a respective predefined event or sub-event is detected, an event recognizer activates an event handler associated with the detection of the event or sub-event. Event handler optionally uses or calls a data updater or an object updater to update an internal state of an application. In some embodiments, an event handler accesses a respective GUI updater to update a user interface displayed in association with the application. Similarly, it would be clear to a person having ordinary skill in the art how other processes can be implemented based on the components depicted in FIG. 5I.

This disclosure, for purpose of explanation, has been described with reference to specific embodiments. The discussions above are not intended to be exhaustive or to limit the disclosure and/or the claims to the specific embodiments. Modifications and/or variations are possible in view of the disclosure. Some embodiments were chosen and described in order to explain principles of techniques and their practical applications. Others skilled in the art are thereby enabled to utilize the techniques and various embodiments with modifications and/or variations as are suited to a particular use contemplated.

Although the disclosure and embodiments have been fully described with reference to the accompanying drawings, it is to be noted that various changes and/or modifications will become apparent to those skilled in the art. Such changes and/or modifications are to be understood as being included within the scope of this disclosure and embodiments as defined by the claims.

It is the intent of this disclosure that any personal information of users should be gathered, managed, and handled in a way to minimize risks of unintentional and/or unauthorized access and/or use.

Therefore, although this disclosure broadly covers use of personal information to implement one or more embodiments, this disclosure also contemplates that embodiments can be implemented without the need for accessing such personal information.

What is claimed is:

1. A method comprising:
at an electronic device in communication with one or more input devices and one or more output devices:
while navigating to a physical location:
in accordance with a determination that a current location of the electronic device at which the electronic device is navigating includes a predetermined path, navigating along the path while forgoing outputting, via the one or more output devices, a user interface for selecting a respective path including the current location of the electronic device along which to navigate; and
in accordance with a determination that the current location of the electronic device at which the electronic device is navigating does not include the predetermined path:
outputting, via the one or more output devices, the user interface for selecting the respective path including the current location of the electronic device along which to navigate; and while outputting the user interface for selecting the respective path, receiving, via the one or more input devices, a user input selecting the respective path; and
in response to receiving the input selecting the respective path:
in accordance with a determination that the input corresponds to a request to select a first path, navigating using the first path; and
in accordance with a determination that the input corresponds to a request to select a second path different from the first path, navigating using the second path.

2. The method of claim 1, wherein the user interface for selecting the respective path includes:
in accordance with a determination that a relationship between dimensions of a vehicle in communication with the electronic device and dimensions of an environment of the vehicle is a first relationship, an indication of a third path corresponding to the first relationship, and
in accordance with a determination that the relationship between the dimensions of the vehicle and the dimensions of the environment of the vehicle is a second relationship different from the first relationship, an indication of a fourth path corresponding to the second relationship, the fourth path different from the third path.

3. The method of claim 1, wherein the user interface for selecting the respective path includes:
in accordance with a determination that weather conditions at the current location of the electronic device are first weather conditions, a third path corresponding to the first weather conditions, and
in accordance with a determination that the weather conditions at the current location of the electronic device are second weather conditions different from the first weather conditions, a fourth path corresponding to the second weather conditions, the fourth path different from the first path.

4. The method of claim 1, wherein:
the user interface for selecting the respective path includes a prompt for the user to create the respective path, and
the user input includes input corresponding to creation of the respective path.

5. The method of claim 1, wherein the user input selecting the respective path includes a voice input.

6. The method of claim 1, wherein the user interface for selecting the respective path includes:
in accordance with a determination that a vehicle in communication with the electronic device previously followed a third path including a current location of the vehicle, an indication of a fourth path based on the third path, and
in accordance with a determination that the vehicle previously followed a fifth path including the current location of the vehicle, the fifth path different from the third path, an indication of a sixth path based on the fifth path, the sixth path different from the fourth path.

7. The method of claim 1, wherein:
in accordance with a determination that a user of the electronic device previously followed a third path including a current location of the electronic device, the user interface for selecting the respective path includes an indication of a fourth path based on the third path, and
in accordance with a determination that the user previously followed a fifth path including the current location of the electronic device, the fifth path different from the third path, the user interface for selecting the respective path includes an indication of a sixth path based on the fifth path, the sixth path different from the fourth path.

8. The method of claim 1, wherein:
in accordance with a determination that a second electronic device previously followed a third path including a current location of the electronic device, the user interface for selecting the respective path includes an indication of a fourth path based on the third path, and
in accordance with a determination that the second electronic device previously followed a fifth path including the current location of the electronic device, the fifth path different from the third path, the user interface for selecting the respective path includes an indication of a sixth path based on the fifth path, the sixth path different from the fourth path.

9. The method of claim 1, further comprising:
receiving, from a second electronic device associated with the current location of the electronic device, path information for the current location of the electronic device, wherein while navigating to the physical location:
in accordance with the determination that that current location of the electronic device at which the electronic device is navigating does not include the predetermined path:
in accordance with a determination that the path information from the second electronic device includes first path information, the user interface for selecting the respective path includes an indication of a third path based on the first path information, and
in accordance with a determination that the path information from the second electronic device includes second path information different from the first path information, the user interface for selecting the respective path includes an indication of a fourth path based on the second path information, the fourth path different from the third path.

10. The method of claim 1, further comprising:
while navigating to the physical location:
detecting, via the one or more input devices, an object in an environment of the electronic device that is not included in map information accessible to the electronic device;
in accordance with a determination that the object satisfies one or more criteria, updating the map information to include information associated with the object; and
in accordance with a determination that the object does not satisfy the one or more criteria, forgoing updating the map information to include the information associated with the object.

11. The method of claim 1, further comprising:
while navigating to the physical location:
at a first time, detecting, via the one or more input devices, an object in an environment of the electronic device that is not included in map information accessible to the electronic device;
at a second time different form the first time, detecting, via the one or more input devices, the object; and
tracking the object in the environment of the electronic device based on detecting the object at the first time and at the second time.

12. The method of claim 1, wherein:
the user interface for selecting the respective path includes representations of one or more path options,
in accordance with a determination that one or more first path options satisfy a set of criteria and one or more second path options different from the one or more first path options do not satisfy the set of criteria, the user interface for selecting the respective path includes representations of the one or more first path options, and
in accordance with a determination that the one or more second path options satisfy the set of criteria and the one or more first path options do not satisfy the set of criteria, the user interface for selecting the respective path includes representations of the one or more second path options.

13. The method of claim 1, wherein:
the user interface for selecting the respective path includes representations of one or more path options,
in accordance with a determination that vehicles in an environment of the electronic device have a first behavior, the user interface for selecting the respective path includes representations of one or more first path options, and
in accordance with a determination that the vehicles in the environment of the electronic device have a second behavior different from the first behavior, the user interface for selecting the respective path includes representations of one or more second path options different from the one or more first path options.

14. The method of claim 1, further comprising while navigating to the physical location and while the current location of the electronic device does not include the predetermined path, detecting, using the one or more input devices, a human in an environment of the electronic device providing path directions, wherein:
the user interface for selecting the respective path includes representations of one or more path options,
in accordance with a determination that the path directions provided by the human include first path directions, the user interface for selecting the respective path includes representations of one or more first path options corresponding to the first path directions, and
in accordance with a determination that the path directions provided by the human include second path directions different from the first path directions, the user interface for selecting the respective path includes representations of one or more second path options different from the first path options corresponding to the second path directions.

15. The method of claim 14, further comprising while navigating to the physical location and while the current location of the electronic device does not include the predetermined path:
in accordance with a determination that the path directions provided by the human fail to meet one or more criteria, presenting the user interface for selecting the respective path including a request for user input to select the respective path.

16. The method of claim 15, wherein:
in accordance with the determination that the path directions provided by the human fail to meet the one or more criteria:
presenting the user interface for selecting the respective path including the request for user input to select the respective path includes presenting, using the one or more output devices, an indication of the respective path and an option that, when selected, causes the electronic device to forgo navigating along the respective path, and
the method further comprises, while navigating to the physical location:
in accordance with a determination that the user interface for selecting the respective path has been presented for greater than a predetermined time threshold, navigating along the respective path.

17. The method of claim 15, wherein:
in accordance with the determination that the path directions provided by the human fail to meet the one or more criteria:
presenting the user interface for selecting the respective path including the request for user input to select the respective path includes presenting a plurality of path options based on the path directions provided by the human.

18. The method of claim 15, wherein:
in accordance with the determination that the path directions provided by the human fail to meet the one or more criteria:
presenting the user interface for selecting the respective path including the request for user input to select the respective path includes presenting a prompt for the user to provide the respective path.

19. The method of claim 1, further comprising:
while navigating to the physical location, in accordance with the determination that the current location of the electronic device does not include the predetermined path:
in accordance with a determination that a vehicle in an environment of the electronic device is traveling along a path that satisfies one or more criteria, navigating along the path along which the vehicle is traveling; and
in accordance with a determination that the vehicle in an environment of the electronic device is traveling along a path that fails to satisfy the one or more criteria, outputting the user interface for selecting the respective path.

20. The method of claim 1, further comprising:
while navigating to the physical location, in accordance with the determination that the current location of the electronic device does not include the predetermined path:
in accordance with a determination that an environment of the electronic device includes one or more objects indicating a path, navigating along the path indicated by the one or more objects; and
in accordance with a determination that the environment of the electronic device does not include the one or more objects indicating the path, outputting the user interface for selecting the respective path.

21. The method of claim 1, wherein outputting the user interface for selecting the respective path includes displaying, via a display component included in the one or more output devices, a visual indication of the respective path.

22. The method of claim 1, wherein:
the user interface for selecting the respective path includes representations of one or more path options,
in accordance with a determination that an environment of the electronic device is a first type of environment, the one or more path options are selected according to a first set of one or more criteria, and
in accordance with a determination that the environment of the electronic device is a second type of environment different from the first type of environment, the one or more path options are selected according to a second set of one or more criteria different from the first set of one or more criteria.

23. An electronic device comprising:
one or more processors;
memory; and
one or more programs, wherein the one or more programs are stored in the memory and are configured to be executed by the one or more processors, the one or more programs including instructions for:
while navigating to a physical location:
in accordance with a determination that a current location of the electronic device at which the electronic device is navigating includes a predetermined path, navigating along the path while forgoing outputting, via one or more output devices, a user interface for selecting a respective path including the current location of the electronic device along which to navigate; and
in accordance with a determination that the current location of the electronic device at which the electronic device is navigating does not include the predetermined path:
outputting, via the one or more output devices, the user interface for selecting the respective path including the current location of the electronic device along which to navigate; and
while outputting the user interface for selecting the respective path, receiving, via the one or more input devices, a user input selecting the respective path; and
in response to receiving the input selecting the respective path:
in accordance with a determination that the input corresponds to a request to select a first path, navigating using the first path; and
in accordance with a determination that the input corresponds to a request to select a second path different from the first path, navigating using the second path.

24. A non-transitory computer readable storage medium storing one or more programs, the one or more programs comprising instructions, which when executed by one or more processors of an electronic device, cause the electronic device to perform a method comprising:
while navigating to a physical location:
in accordance with a determination that a current location of the electronic device at which the electronic device is navigating includes a predetermined path, navigating along the path while forgoing outputting, via one or more output devices, a user interface for selecting a respective path including the current location of the electronic device along which to navigate; and
in accordance with a determination that the current location of the electronic device at which the electronic device is navigating does not include the predetermined path:
outputting, via the one or more output devices, the user interface for selecting the respective path including the current location of the electronic device along which to navigate; and
while outputting the user interface for selecting the respective path, receiving, via the one or more input devices, a user input selecting the respective path; and
in response to receiving the input selecting the respective path:
in accordance with a determination that the input corresponds to a request to select a first path, navigating using the first path; and
in accordance with a determination that the input corresponds to a request to select a second path different from the first path, navigating using the second path.
